(19) United States
(12) Patent Application Publication
(10) Pub. No.: US 2014/0013824 A1
(43) Pub. Date: Jan. 16, 2014

(54) METHOD AND APPARATUS FOR INCREASING THE SPEED AND/OR RESOLUTION OF GAS PERMEATION MEASUREMENTS

(71) Applicant: UNIVERSITY OF FLORIDA RESEARCH FOUNDATION, INC., Gainesville, FL (US)

(72) Inventor: BRUCE A. WELT, GAINESVILLE, FL (US)

(21) Appl. No.: 13/941,225

(22) Filed: Jul. 12, 2013

Related U.S. Application Data
(60) Provisional application No. 61/670,937, filed on Jul. 12, 2012.

(51) Int. Cl. G01N 15/08

(52) U.S. Cl. CPC G01N 15/082
USPC 73/38

(57) ABSTRACT

A method and apparatus is provided for measuring the transmission rate of a substance through a material, such as a packaging film. The transmission rate of the substance during the test can be increased, or decreased, by increasing the pressure, or decreasing the pressure, respectively, at which the test is conducted. Embodiments can use a probe that does not consume the substance. Specific embodiments can utilize flowing gases. Other embodiments do not require any flowing gas during the measurement.

### CROSS-REFERENCE TO RELATED APPLICATION

The present application claims the benefit of U.S. Provisional Application Ser. No. 61/670,937, filed Jul. 12, 2012, which is hereby incorporated by reference herein in its entirety, including any figures, tables, or drawings.

### BACKGROUND OF INVENTION

The shelf life of many packaged products including food, pharmaceuticals, medical products, cosmetics, and chemicals, is sensitive to oxygen. Therefore, it is important to know the oxygen transmission rate (OTR) of the packaging materials in order to maximize the shelf life of packaged products. This is especially true during long-term storage. The presence of oxygen leads to many reactions that can decrease the shelf life. Microbial growth, oxidation of lipids causing rancidity, and senescence of fruits and vegetables all require oxygen to take place. Thus, it is important to industry that the OTR of packaging materials are consistent with the needs of products.

As an alternative to predicting an oxygen transmission rate (OTR), measurement of OTR of plastic packaging films and other semi-barrier materials can also be utilized for studying modified atmosphere packages (MAP). OTR is often quoted as a material specification and provided as a relative value based on standard test conditions of 23° C. and 1 atm partial pressure difference. Tests can also be conducted to determine the transmission rate of a substance, such as oxygen, at temperatures other than 23° C., at various humidities, and/or at partial pressure differences other than 1 atm, producing one or more of a variety of properties of the material and/or sample (such as material permeability and transmission rate for a specific sample material and thickness).

A method to measure OTR is described by ASTM D1434 [ASTM D-1434 Standard Test Method for Determining Gas Permeability Characteristic of Plastic Film and Sheeting, 2009] where a sample forms a sealed barrier between two chambers, a chamber initially containing pure oxygen and an oxygen free chamber. The pressure or volume of the oxygen receiving chamber is monitored over time and OTR is determined from changes in volume or pressure. This method has been used by a number of researchers, but it is experimentally difficult and not considered as accurate as other methods. One of the most popular methods for measuring OTR is ASTM D-3985 [ASTM D-3985 Standard Test Method for Oxygen Gas Transmission Rate Through Plastic Film and Sheeting Using a Coulometric Sensor, 2010], which is used by many researchers. ASTM D3985 is considered to be a steady-state method using a coulometric sensor. Commercially available instruments have been developed around ASTM D-3985 and are available from several vendors including Illinois Instruments (Johnsburg, Ill., USA) and Mocon, Inc. (Minneapolis, Minn., USA).

The steady state method (ASTM D3985) involves measurement of trace amounts oxygen in a steady stream of oxygen-free carrier gas. FIG. 1A shows FIG. 1 of the 2010 ASTM D3985 description. Implementing the steady state method (ASTM D3985) typically involves the use of an extremely sensitive oxygen sensor, which can often require continuous protection from atmospheric oxygen and frequent replacement. Further, a test for measuring the oxygen concentration of a package's headspace within a sealed package without opening or compromising the integrity of the package is ASTM F2714-08 (Standard Test Method for Oxygen Headspace Analysis of Packages Using Fluorescent Decay).

Measuring OTR using the steady state method involves a permeation cell where the sample material separates two chambers. Different gases pass on either side of the sample film. An oxygen rich gas, typically air or pure oxygen, passes on one side of the sample while an oxygen deficient carrier gas, such as nitrogen, passes on the opposite side. Oxygen permeates from the side with high concentration, through the film and into the oxygen deficient carrier gas stream. After leaving the sample chamber, the carrier gas passes through a coulometric oxygen sensor to measure oxygen concentration in the carrier gas. OTR is estimated using carrier gas flow rate, concentration of oxygen in the carrier gas, and sample permeation area. Since the oxygen partial pressure difference is held constant, this method is also referred to as steady state. This steady state process is depicted in FIG. 1B, where the carrier, or forming, gas flow in can, in a specific embodiment, be 96% N₂ and 4% H₂, and the carrier gas plus permeated test gas flow out is then sent to a coulometric oxygen sensor.

Another method, referred to as Dynamic Accumulation (DA), was described by Abdellatief and Welt [Abdellatief, A. and Welt, B. A. (2012), Comparison of New Dynamic Accumulation Method for Measuring Oxygen Transmission Rate of Packaging against the Steady-State Method Described by ASTM D3985. Packag. Technol. Sci. doi: 10.1002/pts.1974], Abdellatief and Welt [Abdellatief A, Welt B A. Method for Measuring the Oxygen Transmission Rate of Perforated Packaging Films. Journal of Applied Packaging Research, 2009; 3(3), pp. 161-171.] Other attempts at using DA have been described by Ghosh and Anantheswaran [Ghosh V, Anantheswaran R C. Oxygen Transmission Rate through Micro-Perforated Films: Measurement and Model Comparison. Journal of Food Process Engineering. 2001; 24(2), pp. 113-133.], Kim et al. [Kim J G; Luo Y G; Gross K C, 2004. Effect of package film on the quality of fresh-cut salad savoy. Postharvest Biology and Technology, 2004; 32(1), pp. 99-107.] Moyls et al. [Moyls L, Hocking R, Beveridge T, Timbers G. Exponential decay method for determining gas transmission rate for films. Transactions of the ASAE. 1992; 35(4), pp. 1259-1265.; Moyls A L, Whole bag method for determining oxygen transmission rate, Transactions of the ASAE, 2004; 47(1), pp. 159-164.], but these methods differed in that gas samples were removed from the permeation chamber for analysis. Siro et al. [Siro I, Plackett D, Sommer-Larsen P. A Comparative Study of Oxygen Transmission Rates through Polymer Films Based on Fluorescence Quenching. Packaging Technology and Science, 2010; 23(6), pp. 302-315.] described a method similar to Abdellatief and Welt [Abdellatief A, Welt B A. Method for Measuring the Oxygen Transmission Rate of Perforated Packaging Films. Journal of Applied Packaging Research, 2009; 3(3), pp. 161-171.], but with a linear approximation to the exponentially asymptotic behavior. The DA method involves measurement of the rate of change of oxygen concentration in a chamber or package. In previous applications of DA, researchers periodically withdrew gas from the accumulation chamber and measured oxygen via gas chromatograph. Withdrawing gas from the accumulation chamber is not desirable since each sample taken changes conditions of the experiment. Moyls et al. [Moyls L, Hocking R, Beveridge T, Timbers G. Exponential decay method for determining gas transmission rate for films. Transactions of the ASAE. 1992; 35(4), pp. 1259-1265.] withdrew few and small samples in an attempt to minimize errors due to sampling. Ghosh and Anantheswaran [Ghosh V, Anantheswaran RC. Oxygen Transmission Rate through Micro-Perforated Films: Measurement and Model Comparison. Journal of Food Process Engineering. 2001; 24(2), pp. 113-133.] restarted tests after each sample was taken resulting in very long test times.

For the steady state method (ASTM D3985) each reading represents an independent observation, and is taken as the system has, hopefully, reached a steady state. Since there is no convenient way to know when the system reaches steady state, researchers typically take many readings, or observations, and arbitrarily stop experiments when consecutive results appear to be sufficiently similar so as to suggest the system has reached steady state. For the dynamic accumulation method, each experimental result relies on multiple readings, or observations, of oxygen concentration that describe the trend of dynamically changing oxygen concentration, which is also inherently proportional to OTR. The dynamic accumulation method is robust since random errors tend to cancel each other out about the trend line and each reading, or observation, adds confirmation and statistical confidence in the result.

These fundamental differences lead to very different sensor performance requirements between the steady state and dynamic accumulation methods. Very sensitive sensors are typically used for the steady state approach since it relies on instantaneous measurements of trace concentrations of oxygen in the carrier gas. Since the dynamic accumulation approach relies on the rate-of-change of oxygen concentration (slope) rather than one extremely low concentration, sensors with much less sensitivity may be used. In specific embodiments utilizing the dynamic accumulation method, sensors capable of resolving 0.05% oxygen have been more than adequate. As barrier properties of samples increase, the steady state method requires increasingly sensitive sensors in order to achieve sufficient signal-to-noise performance. In practice, measurement noise increases substantially for the steady state method as sample OTR decreases, making it increasingly difficult for researchers to know when to terminate experiments with confidence. There is no such restriction or issue with respect to measurement noise with the dynamic accumulation method; however, for any given sensor resolution, experiment time increases as OTR decreases. Experimental time also tends to increase with decreasing OTR for the steady state approach, but only because it takes longer to reach steady state in materials with greater barrier properties and it also tends to take longer to more thoroughly purge instruments after samples are mounted. Therefore, robust low cost sensors may be successfully used for the dynamic accumulation method, whereas relatively expensive and sensitive sensors are generally required for the steady state method.

Another important operational comparison between the steady state method and the dynamic accumulation method is in consumption of gases and sensors. The steady state method requires flowing gases through experiments. When not in use, instruments designed for the steady state method typically require a constant flow of purge gas in order to protect the sensitive sensor from atmospheric oxygen. For steady state instruments designed for high barrier films with extremely sensitive sensors, special mixtures of purge gas that contain a few percent hydrogen are recommended in order to catalytically remove trace amounts of oxygen in the purge gas itself. As these sensors are continuously consumed by exposure to oxygen, performance declines until sensor replacement is required and this typically requires a specially trained technician. For the dynamic accumulation method using fluorescence based sensors, sensor cost is extremely low, sensor life is very long and the sensors do not need to be constantly protected from oxygen with an oxygen free purge gas when the sensor is not in use. The dynamic accumulation method does not require expensive gas blends and can be performed with a minimum of industrial grade nitrogen available from any commercial gas supplier or on-site nitrogen generator. The purge gas used for the dynamic accumulation method need not be free of oxygen. Rather, if oxygen is present in the purge gas for the dynamic accumulation method, the concentration can be conveniently measurable and taken into account. The dynamic accumulation method consumes very little gas as compared to the steady state method. Purge gas can be used to start an experiment by purging the oxygen accumulation chamber, but once purged, the chamber can be sealed and no additional gas used. Since the dynamic accumulation method does not require flowing gases to make a measurement, the method is also useful for measuring samples with perforations, such as microperforated films, which is often not practical with the steady state approach.

Recent advances in fluorescence-based oxygen measurement have created an opportunity for improving the dynamic accumulation method for measuring OTR [Siro I, Plackett D, Sommer-Larsen P. A Comparative Study of Oxygen Transmission Rates through Polymer Films Based on Fluorescence Quenching. Packaging Technology and Science, 2010; 23(6), pp. 302-315.]. Fluorescence oxygen measurement combined with optical fiber probes provides the ability to measure oxygen non-destructively. Therefore, oxygen measurements may be made in-situ in real-time.

Coulometric sensors may be damaged by condensation when operated below 10° C. and then brought back to warmer temperatures. This is particularly problematic for many refrigerated or frozen food and pharmaceutical packaging applications (Abdellatief A, Welt B A. Method for Measuring the Oxygen Transmission Rate of Perforated Packaging Films. Journal of Applied Packaging Research, 2009; 3(3), pp. 161-171). Fluorescent based oxygen sensors are capable of measuring oxygen in gases and liquids so there is no damage due to condensation when exposed to colder and then warmer temperatures. In fact, fluorescence based oxygen sensors are routinely used by environmental scientists to measure oxygen concentrations in lake and sea floor sediments.

Traditional methods for measuring OTR include manometric, volume, coulometric, and concentration increase methods. For manometric and volume methods, a sample is typically mounted in a gas transmission cell to form a sealed semibarrier between two chambers. One chamber contains test gas at a specific high pressure, and the other chamber, which is at a lower pressure, receives the permeating gas. In the manometric method, the lower pressure chamber is evacuated and transmission of the gas through the film is indicated by an increase in pressure. In the volume method, the lower pressure chamber is maintained at atmospheric pressure and the gas transmission is indicated by a change in volume.

Specific embodiments of the coulometric method, an example of which is illustrated in FIG. 1B, involves mounting a specimen as a sealed semi-barrier between two chambers at atmospheric pressure. Referring to FIG. 1B, instrumentation supplied by Mocon, Inc. (Minneapolis, Minn.) for implementing the coulometric approach is shown. FIG. 1B shows a procedure where oxygen would permeate from the lower outer chamber test cell to top inner chamber test cell through the test film mounted between them. Here, the test film splits the test chamber into two halves. An oxygen containing gas (test gas) flows through the outer chamber test cell while an oxygen free gas (carrier gas) flows through the inner chamber test cell. The inner chamber is purged with a non-oxygen containing carrier gas, such as nitrogen, and the other chamber is purged with an oxygen containing test gas, which is typically ambient air (21% oxygen) or 100% oxygen. Oxygen permeates through the film into the carrier gas, which is then transported to a coulometric sensor. Oxygen is consumed in a process that generates an electric current proportional to the amount of oxygen flowing to the sensor in a given time period.

This coulometric system works well for film samples without perforations since slight variations of pressure on either side of the sample do not significantly alter measurements. However, with perforated films, variations in pressure can cause gas to flow freely from one side to the other, which directly affects oxygen measurements. Further, the coulometric system may not work well with non-perforated film samples having very high barrier characteristics, if the amount of substance passing through the film sample is too small to detect or detect accurately. The concentration increase method, illustrated, for example, in FIG. 2, is an unsteady state method where the chamber is sealed with a semi-barrier and is initially purged with an oxygen free gas, such as nitrogen. Oxygen diffuses through the barrier film and/or perforations, and the concentration of oxygen in the chamber is measured over time. The most common method used to measure the oxygen concentration is a gas chromatograph, which typically involves removal of gas samples from the test chamber, as illustrated by use of the syringe in FIG. 2. FIG. 2 shows a method for measuring OTR that requires headspace sampling over time (unsteady state measurement of headspace over time). Actual experiments often require removal of multiple samples from a single test specimen. Without perforations in the sample material, each sampling changes headspace volume, which affects the measurement. With perforations in the sample material, each sampling draws new gas into the headspace so as to change gas compositions, thus affecting subsequent samples.

Regarding the dynamic accumulation/concentration change approach, as gas barrier properties of materials increases (i.e., decreasing gas permeation), the time required to change gas concentrations increases. Many food, drug, cosmetic, and chemical packaging applications require significant gas barrier properties to preserve product quality. Accordingly, for samples with high gas barrier properties, methods relying on measuring trends in concentration changes, such as rate of change of concentration, may require significant amounts of time. Regarding the steady state approach, sensor sensitivity is often increased as barrier properties increase.

Accordingly, there exists a need in the art to accelerate measurements, in order to reduce measurement times, for methods to measure the oxygen transmission rate of materials using trends in concentration changes, such as rate of change of concentration, as the basis of measurement. Also, there exists a need to improve performance of measurements when the steady-state approach is used.

### BRIEF SUMMARY

Embodiments of the present invention provide a method and apparatus to measure the oxygen transmission rate (OTR) of a material. Further embodiments can measure the transmission rates of other gases and/or vapors such as, but not limited to, carbon dioxide, water vapor, nitrogen, carbon monoxide, helium, hydrogen, ammonia, nitrogen oxides (NOx), sulfur oxides, hydrogen sulfide, hydrogen chloride, and aroma compounds. Embodiments can also be used to measure the transmission rates of dissolves gases and solutes in liquids and/or solvents, through a sample. The method and device can be utilized to determine the OTR of a semi-barrier material. In specific embodiments, the methods may be used to test the OTR through non-perforated materials, such as non-perforated packaging films. Further specific embodiments can test OTR through perforated methods.

Specific embodiments for measuring the transmission rates of dissolved gases, such as oxygen, in liquid, can control the pressure over the liquid to be above, or below, atmospheric pressure, which can impact the amount of gas dissolved in the liquid. In this way, the pressure of the gas over the liquid can be controlled and maintained above, or below, atmospheric pressure.

Specific embodiments relate to controlling or altering the absolute pressures on both sides of a sample, such that the absolute pressures on both sides of the sample are above atmospheric pressure, or below atmospheric pressure, for at least a portion of the testing procedure, where the testing procedure determines one or more aspects of a substance's transmission properties through a sample. Further, embodiments can allow the pressure on one side of the sample to be atmospheric pressure and the pressure on the other side of the sample to be above, or below, atmospheric pressure, and can, optionally, control the pressure differential to be a desired pressure differential or within a desired tolerance of the desired pressure differential.

Specific embodiments of the subject methods relate to measuring the oxygen transmission rate (OTR) of materials using a dynamic accumulation method and/or flow through, or steady state, method. Specific embodiments implement methods in accordance with the American Society for Testing Material (ASTM) method ASTM D1434 (manometric method), ASTM D1434 (volume method), and/or ASTM D3985 (coulometric sensor method) for measuring OTR through barrier plastic films (i.e., films without perforations), and may also apply such methods to films having perforations. Further specific embodiments implement methods in accordance with ASTM F2714-08 (Standard Test Method for Oxygen Headspace

Analysis of Packages Using Fluorescent Decay).

In an embodiment, OTR can be measured using a steady-state method, incorporating a permeation cell where the sample material separates two chambers. Gases at similar absolute pressures, above or below atmospheric pressure, and flow rates pass on either side of the sample film. An oxygen rich gas (e.g., air or pure oxygen) passes on one side while an oxygen deficient gas (e.g., nitrogen) passes on the other side of the film sample. After transmission of some oxygen through the film sample, the oxygen deficient gas stream with the oxygen that permeated, or otherwise traveled through the film sample, passes through an oxygen sensor to measure the amount of oxygen permeating through the fixed sample area. Since the absolute pressure is the same on both sides, this method is referred to as isostatic. Since the oxygen partial pressure difference is held constant, this method is also referred to as steady-state. A prior art isostatic, steady-state process is depicted in FIG. 1B.

ASTM D-3985 specifies a coulometric sensor for oxygen detection and measurement. FIG. 1A shows a system shown in FIG. 1 of the 2010 ASTM D-3985 description. Such sensors are extremely sensitive to oxygen and are, therefore, relatively expensive to acquire and maintain. Most coulometric sensors have a limited life span that depends upon overall exposure to oxygen. Additionally, to minimize interference from oxygen contaminated process gases, a special nitrogen/hydrogen mixture is typically required in order to catalytically remove trace amounts of oxygen in test gases. Such gas mixtures tend to be more expensive than unmixed nitrogen by a factor of about 10 and the sensor is often constantly bathed in a stream of oxygen-free gas for longevity. Costs of process gases and sensor replacements add considerably to OTR testing costs using this method.

A specific embodiment of one of the subject methods pertains to improvement of performance of the steady state method such that less sensitive and less costly sensors may be employed in the measurement of OTR using the steady-state method. Alternatively, the subject method may be used instead with increasingly sensitive sensors to extend the normal operating envelope of the measurement to include materials of even greater barrier properties than the prior method permitted.

Another specific embodiment of the subject method pertains to a static method that does not require flowing gases during measurement. The absence of flowing gases reduces, or eliminates, the need for expensive hardware to precisely control pressures and gas flow rates. A permeation cell for an embodiment of a dynamic accumulation method can be similar to the permeation cell used by the steady-state method. Advantageously, in specific embodiments, there is no need for expensive specialty gases and the gases used do not need to be flowing constantly during or between measurements. Therefore, very little gas is used or consumed compared with the steady state method. An oxygen deficient gas can be used (e.g., nitrogen) to purge the sensor-side of the permeation cell to initiate the test, where once purged, the chamber valves can be sealed. The oxygen enriched side may be left open to the atmosphere, flushed with air using a pump or compressed air, or flushed with pure oxygen. A dynamic accumulation permeation cell with oxygen flush gas is depicted in FIG. 3. Note, FIG. 3 does not show the portion of the oxygen probe inside the accumulation chamber.

In certain embodiments of the invention involving dynamic accumulation, a fiber optic oxygen sensor is utilized to detect oxygen, so as to measure the OTR for a material. Specific embodiments utilize a fiber optic oxygen sensor that does not consume oxygen. In specific embodiments, the fiber optic oxygen sensor is capable of sensing oxygen without using continuously flowing gases, consuming oxygen during measurement, or requiring removal of gas from a chamber for measurement. The fiber optic oxygen sensor may also be referred to as an oxygen probe that incorporates an oxygen sensor, where the oxygen sensor is the portion of the oxygen probe that experiences a physical change in the presence of oxygen and other portions of the oxygen probe perform other functions in the detection of oxygen. Specific oxygen probes can incorporate a fluorescence based oxygen sensor in contact with the volume in which oxygen is to be measured. Fluorescence based oxygen probes can be based on the presence of oxygen reducing the intensity of fluorescence and the concentration of the oxygen present affecting the degree of intensity reduction. Fluorescence based oxygen probes can also be based on the presence of oxygen affecting the decay rate of fluorescence and the concentration of the oxygen present altering the amount of the effect on the decay rate of the fluorescence. Fluorescence based oxygen probes can also be based on the presence of oxygen causing a phase shift in the fluorescence. FIGS. 7A and 7B show examples of two fluorescence based oxygen probes that can be used with embodiments of the subject invention, such as the embodiment shown in FIG. 3. In further specific embodiments, sensors that consume or remove 5% or less of the oxygen, or other gas being measured, can be used. Fiber optic sensors with appropriate sensor substances can be used for a variety of substances. The subject invention can also utilize thermal conductivity detectors, infrared oxygen probe, and electronic nose sensors based on conductivity due to solubility in a substrate, and/or other sensors known in the art for detecting the substance being measured.

Specific embodiments of the subject dynamic accumulation method allow for oxygen, and/or another gas, to transfer through a given cross-sectional area of a sample, such as packaging or sample film, and accumulate over time. The test volume can incorporate a fluorescence based oxygen sensor that does not consume oxygen and, therefore, does not interfere with real-time measurement of oxygen concentration. An embodiment of the method was tested against a widely used, commercially available instrument (Mocon Oxtran 2/20, Minneapolis, Minn.) designed around the steady state gas permeation measurement approach described by ASTM D-3985. Sample films were chosen to provide comparison over several orders of magnitude of OTR. Specifically, sample films with OTR values in the range of 10¹, 10³ and 10⁴ ccO₂/m²/day were measured and results using the two methods were compared.

Results showed that the embodiment of the subject dynamic accumulation method provides comparable results to the widely accepted steady-state method.

### BRIEF DESCRIPTION OF DRAWINGS

In order that a more precise understanding of the above recited invention be obtained, a more particular description of the invention briefly described above will be rendered by reference to specific embodiments thereof that are illustrated in the appended drawings. Understanding that these drawings depict only typical embodiments of the invention and are not therefore to be considered as limiting in scope, the invention will be described and explained with additional specificity and detail through the use of the accompanying drawings in which:

FIG. 1A shows a Figure from the 2010 ASTM D3985 description.

FIG. 1B shows a typical apparatus for measuring oxygen transmission rate (OTR) using a coulometric method.

FIG. 2 shows an apparatus for measuring OTR, which requires headspace sampling over time (unsteady state measurement of headspace over time).

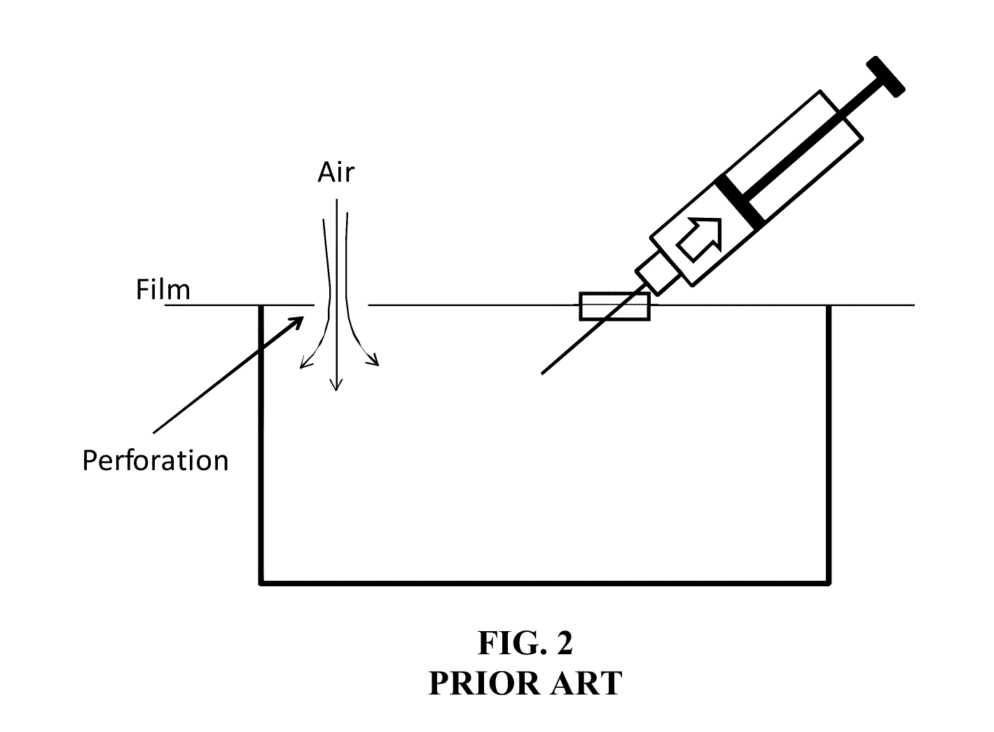

FIG. 3 shows a set-up for an embodiment of a dynamic accumulation method, in accordance with the subject invention, utilizing a permeation cell with a fluorescence sensor and probe.

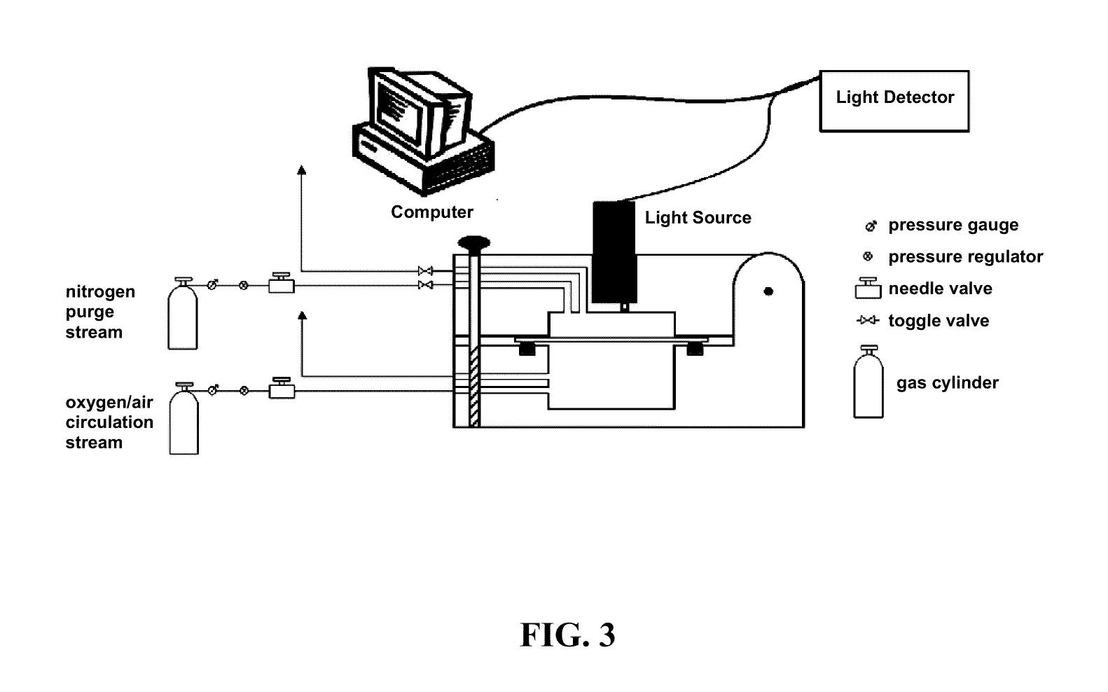

FIG. 4 shows a schematic profile of an OTR chamber according to an embodiment of the present invention.

FIG. 5 shows an embodiment of a dynamic oxygen accumulation permeability measurement system in accordance with the subject invention.

FIG. 6A shows a dynamic accumulation permeation cell in accordance with an embodiment of the subject invention.

FIG. 6B shows a dynamic accumulation permeation cell, showing inlet and exit valves on the inlet and outlet, in accordance with an embodiment of the invention.

FIGS. 7A and 7B show fluorescent probes based on quenching fluorescent intensity (FIG. 7A) and altering a fluorescent decay constant (FIGS. 7A and 7B).

FIG. 8 shows a typical data trace for a dynamic accumulation test (OTR=794 cc/m2/day).

FIG. 9 shows a mounting with a sample film mounted.

### DETAILED DISCLOSURE

Specific embodiments relate to a method for measuring oxygen transmission rate (OTR) of materials using a dynamic accumulation method. Other embodiments relate to a method for measuring OTR using the steady state method. Specific embodiments of the subject invention utilizing the dynamic accumulation method can provide one or more improvement(s) over the traditional steady-state method in terms of result quality and reduced operating cost. The test time for the dynamic accumulation method tends to increase with increases in the gas barrier property of the material. Specific embodiments control and/or alter the absolute pressure on both sides of a sample to be above or below atmospheric pressure, where having the absolute pressure on both sides of the sample above atmospheric pressure can speed up the transmission of a substance through the sample, while having the absolute pressure on both sides of the sample below atmospheric pressure can slow down the transmission of a substance through the sample.

Further embodiments can measure the transmission rates of other gases and/or vapors such as, but not limited to, carbon dioxide, water vapor, nitrogen, carbon monoxide, helium, hydrogen, ammonia, nitrogen oxides (NOx), sulfur oxides, hydrogen sulfide, hydrogen chloride, and aroma compounds. The method and device can be utilized to determine the OTR of a semi-barrier material.

Additional embodiments can be used to test transmission of dissolved gasses and/or solutes in liquids and/or solvents. Examples of liquids and/or solvents that can be used to test the transmission of a dissolved gas and/or solute include, but are not limited to, water, oil, alcoholic beverages, sodas, carbonated beverages, ketchup, mayonnaise, guacamole, wine, beer, and milk. Specific embodiments separate at high pressures, such as 50,000-100, - - - psig, 10,000-50,000 psig, 5,000-10,000 psig, and/or above 100,000 psig. Other embodiments can operate at lower pressures, such as below 0 psig, or above 0 and up to 5,000 psig. Specific embodiments are useful with respect to high pressure hydraulic cutting and/or high pressure, non-thermal pasteurization systems (“pascalitation”) that operate in the range up to 50,000 psig and/or up to 100,000 psig. Psig refers to the pressure on the gauge such that a pressure gauge that “reads” 0 psig is typically reading a pressure of 1 atm, which is approximately 14.7 psi. Psia refers to the absolute pressure such that the psif is typically 14.7 psi below the psia or psi.

In specific embodiments, the method may be used to test the OTR on a perforated film packaging material. In further embodiments, the method and devices can be used to measure flow rates through non-perforated materials, such as non-perforated films.

The traditional steady-state method requires a very sensitive sensor and/or is limited with respect to the level of barrier that can be measured. The traditional steady-state method involves flushing, or flowing, different gases at specific flow rates on opposite sides of a material sample, or film. Minute amounts of gas pass through the material and enter the opposite gas stream. The relative amount of transmitted gas carried away depends upon the flow rates of gases across the film. In order to be able to make measurements, flow rates are usually low and sensors capable of detecting small amounts of transmitted gas are used. Expensive gases are often used to protect delicate sensors from gas. As barrier properties increase, meaning the material sample, or film, allows less gas to transmit from one side of the material sample to the other, sensor noise, flush contamination and small system leaks become increasingly problematic. Embodiments of the subject method permit measurement of samples with either less sensitive sensors or samples of significantly greater barrier properties than the traditional steady-state method, where greater barrier properties means that the amount of the gas transmitted from one side of the sample to the other is lower as a function of time. Specific embodiments of the subject method and apparatus have shown a 50 times improvement, meaning that meaningful results were obtained for material samples having barrier properties 50 times higher than material samples having the highest barrier properties for which meaningful results can be obtained for the traditional steady-state method.

Embodiments of the subject method and apparatus address deficiencies of the traditional steady-state method and can also address deficiencies of the dynamic accumulation method. Increasing the rate of transmission of the gas through the material sample, and, thus, reducing the time of measurement can be accomplished by conducting the test at overall absolute pressures above atmospheric pressures, where the rate of transmission is a function of overall absolute pressure. Specific embodiments raise the overall absolute pressure at which the test is conducted in order to increase the rate of transmission of the gas through the material sample, and, thus, reduce the time of the measurement. Further embodiments increase the pressure the test is conducted to at least a psig at least greater than 0, at least 100 psig, at least 200 psig, at least 300 psig, at least 400 psig, at least 500 psig, at least 600 psig, at least 700 psig, and/or in the range 700-1000 psig. In a further specific embodiment, the pressure is maintained during the measurements at a pressure at least 1500 psig, at least 3000 psig, at least 6000 psig, and/or between 700 psig and 6000 psig. Specific embodiments can have absolute pressures of at least 1.1 atm, 1.2 atm, 1.25 atm, 1.3 atm, 1.4 atm, 1.5 atm, 1.6 atm, 1.7 atm, 1.8 atm, 1.9 atm, and/or 2 atm. Tests can also be conducted in a range of 6,000 to 10,000 psig, or higher, depending on the material used in the testing system. In still further specific embodiments, the pressure is maintained during the measurements at a pressure in the range 500-700 psig, where common gas tanks are pressurized to about 1500 psig, 3000 psig, or 6000 psig, and 500-700 psig allows a good balance between the number of uses from a commercial gas cylinder at 3000 psig and the speed of the test.

In specific embodiments, the pressure on one side of the sample is within 0.1%, 0.5%, 0.6%, 0.7%, 0.8%, 0.9%, 1%, 1.5%, and/or 2.0% of the pressure on the other side of the sample. In further embodiments, the pressure differential between the pressure on one side of the sample and the pressure on the other side of the sample is maintained within 20 psi, 19 psi, 18 psi, 17 psi, 16 psi, 15 psi, 14 psi, 13 psi, 12 psi, 11 psi, 10 psi, 9 psi, 8 psi, 7 psi, 6 psi, 5 psi, 4 psi, 3 psi, 2 psi, and/or 1 psi. Specific embodiments can maintain the ratio of the absolute pressure of the interior (where the substance travels to) to the absolute pressure of the exterior (where the substance travels from) when the pressure of the interior is higher than the pressure of the exterior, or the ratio of the absolute pressure of the exterior to the absolute pressure of the interior when the pressure of the exterior is higher than the pressure of the interior, to be less than or equal to 1.01, 1.02, 1.03, 1.04, 1.05, 1.06, 1.07, 1.08, 1.09, and/or 1.1. Specific embodiments can maintain the ratio of the absolute pressure of the interior to the absolute pressure of the exterior when the pressure of the interior is less than the pressure of the exterior, or the ratio of the exterior pressure to the interior pressure when the exterior pressure is less than the interior pressure, to be at least 0.9, 0.91, 0.92, 0.93, 0.94, 0.95, 0.96, 0.97, 0.98, and/or 0.99.

Specific embodiments can lower the overall absolute pressure at which the test is conducted in order to decrease the rate of transmission of the gas through the material, and, thus, increase the time of the measurement. Such embodiments can be useful for tests conducted on, for example, perforated films where the transmission rate can be high.

The incorporation of absolute pressures above atmospheric pressure or below atmospheric pressure can be utilized with steady state techniques where the gases or liquids are flowed across the surface of the sample to keep the concentration constant and with dynamic accumulation techniques where the gas concentration changes with time in the accumulation chamber (interior) and/or the exterior, as the transport of the substance through the sample occurs with time. Absolute pressures higher than atmospheric pressure can increase the sensitivity of the measurement such that probes with lower sensitivities can be used, samples with lower transmission rates for the substance can be tested, and/or the time for the test can be shortened. Absolute pressures below atmospheric pressure can allow more accurate testing of samples where the test is very short at atmospheric pressure, by extending the time it takes the substance to travel through the sample. Embodiments can also speed up the test by increasing the partial pressure of the gas, such as oxygen, by, for example, using pure oxygen (or mixture with oxygen ratio higher than air) rather than air.

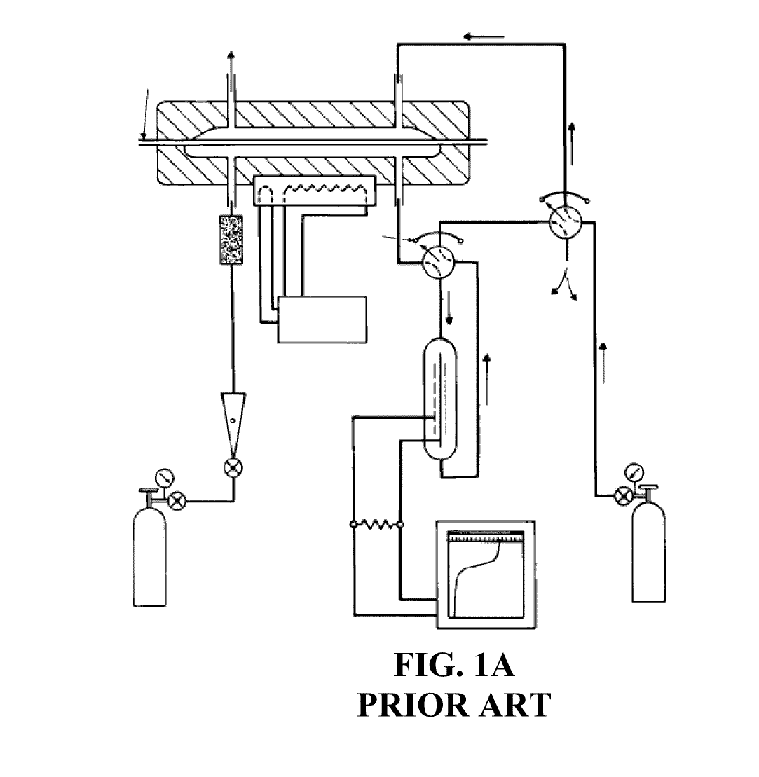

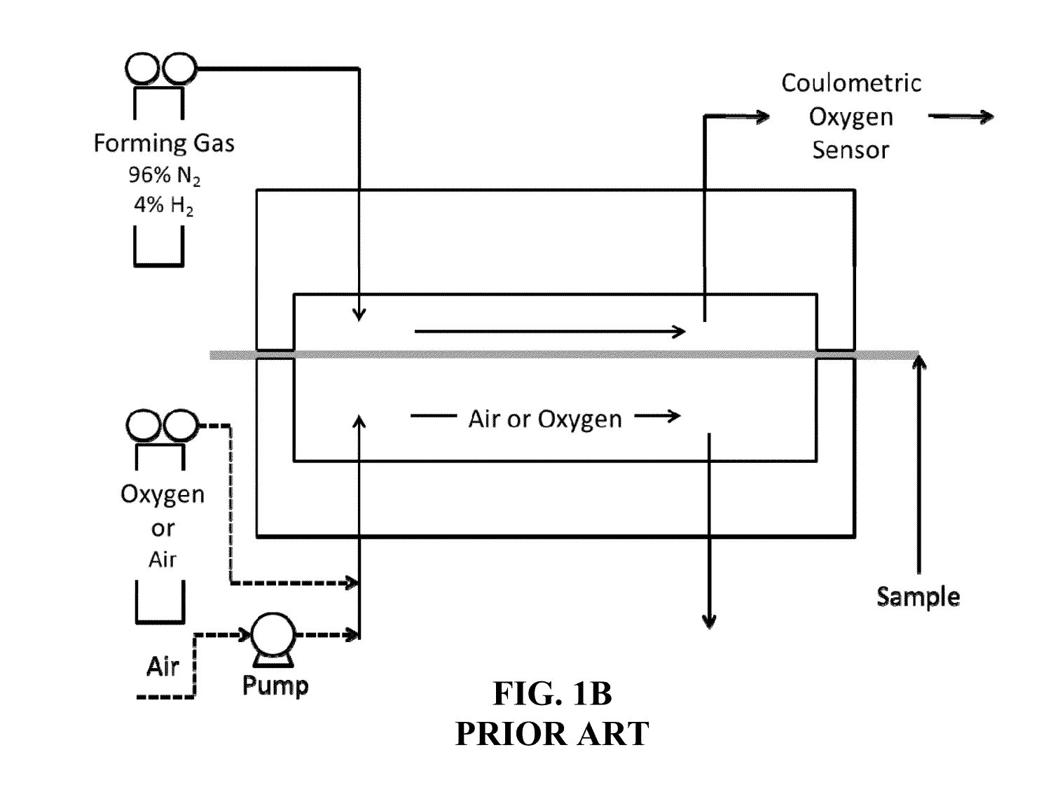

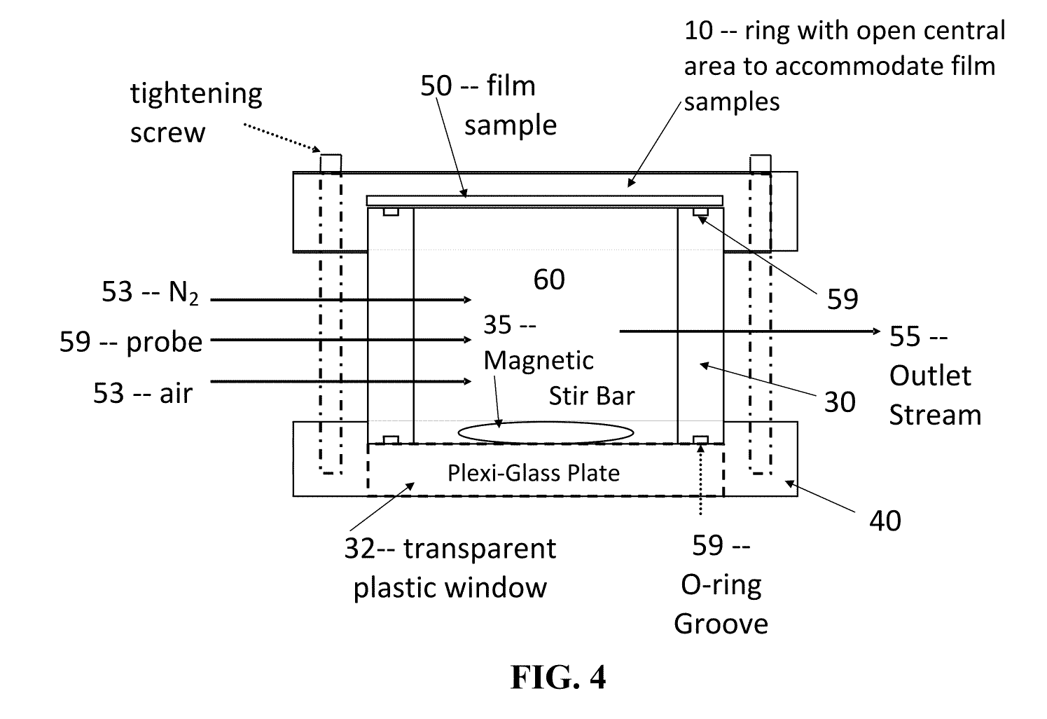

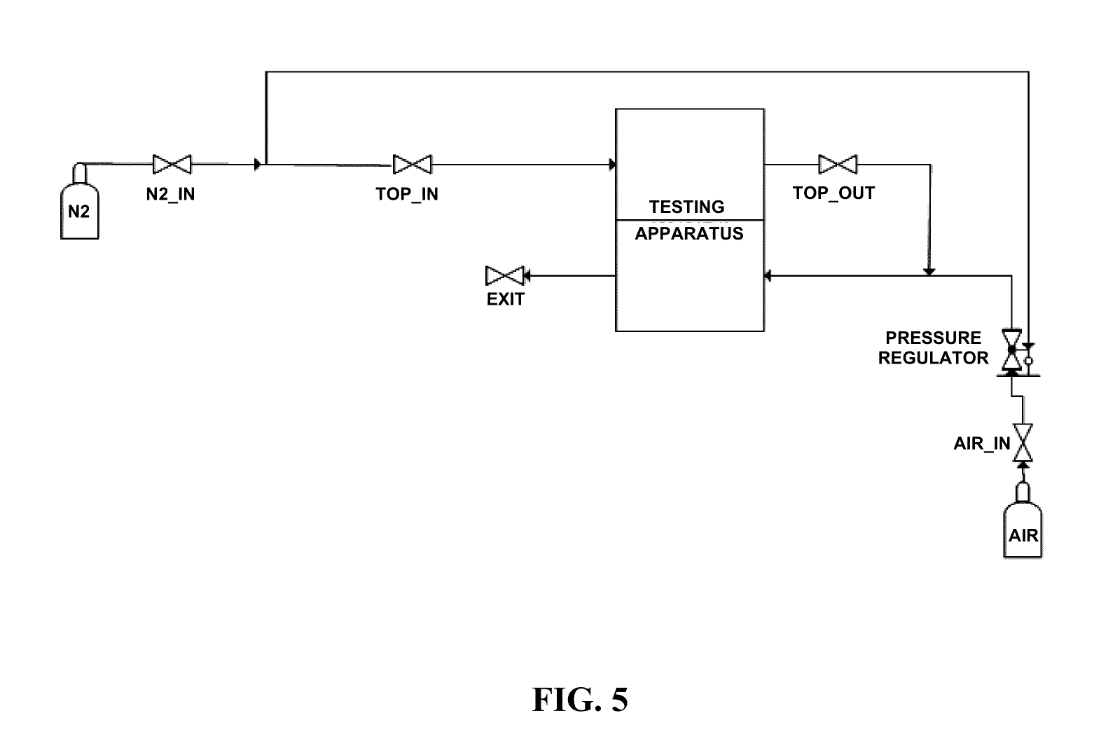

Traditionally, steady-state and dynamic accumulation gas permeation tests are done at atmospheric pressure due in part to the difficulty of precisely matching pressures that are higher or lower than atmospheric pressure on both sides of the material sample, which is often a thin and flexible film. To operate at pressures higher than atmospheric pressure, for example, in accordance with embodiments of the subject method, techniques are employed to bring the pressure up, to maintain the pressure, and, optionally, to then release the pressure, while avoiding inelastic strain on the sample specimen. A specific embodiment can utilize a test cell as shown in FIG. 1B, where the pressure in each of the flow chambers is controlled, and raised above atmospheric pressure during the test. A further embodiment can utilize a test cell as shown in FIG. 4, where the pressure on the interior of the chamber and the pressure in a portion of the exterior of the chamber, in which the substance to be exposed to the sample is present, are controlled, and raised above atmospheric pressure during the test. FIG. 5 shows a dynamic accumulation measurement system that can be used at pressures above atmospheric pressure.

To operate at pressures lower than atmospheric pressure, for example, in accordance with embodiments of the subject method, techniques are employed to bring the pressure down, to maintain the pressure, and, optionally, to bring the pressure back up while avoiding inelastic strain on the sample specimen. A further embodiment can utilize a test cell as shown in FIG. 1B, where the pressure in each of the flow chambers is controlled, and lowered below atmospheric pressure during the test as shown. A further embodiment can utilize a test cell as shown in FIG. 4, where the pressure on the interior of the chamber and the pressure in a portion of the exterior of the chamber, in which the substance to be exposed to the sample is present, are controlled, and lowered below atmospheric pressure during the test. FIG. 5 shows a dynamic accumulation measurement system that can be used at pressures below atmospheric pressures.

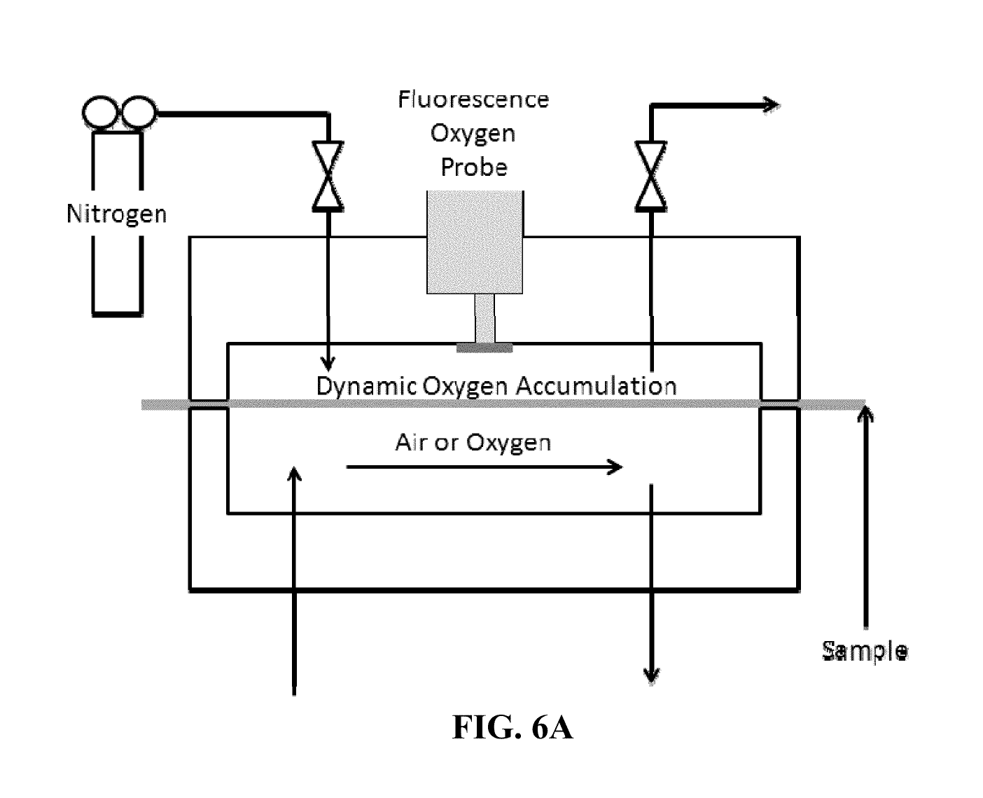

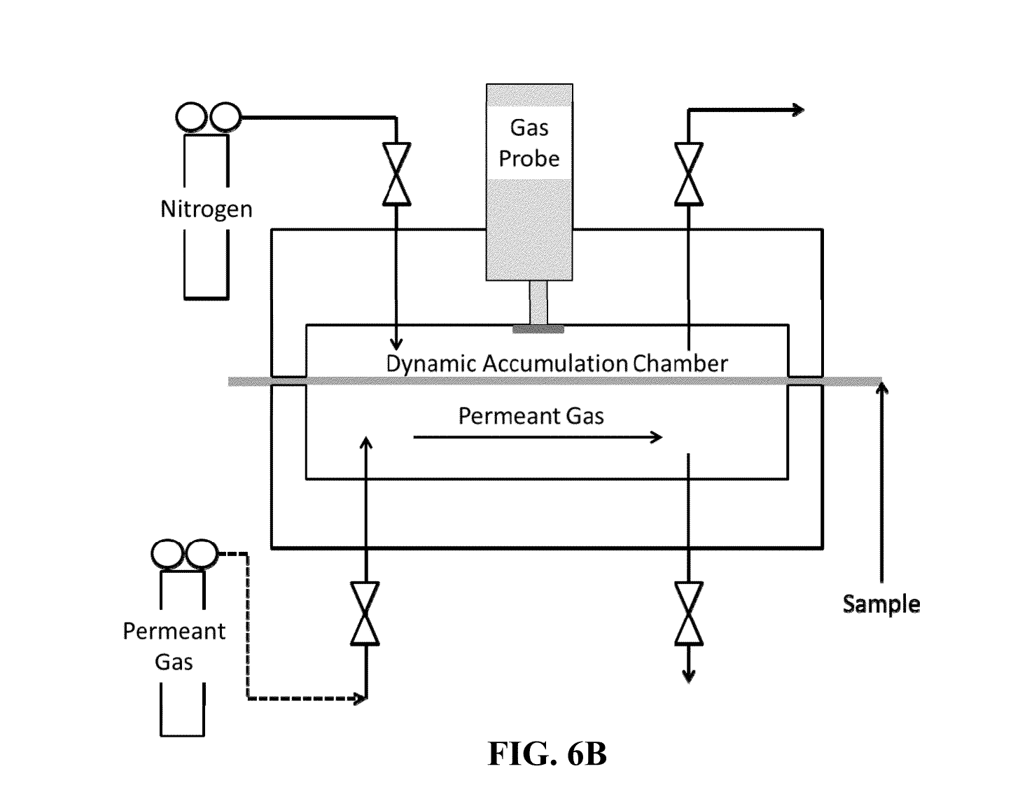

An embodiment of a dynamic accumulation permeation cell is depicted in FIG. 6A. FIG. 6B shows the cell of FIG. 6A with values on the inlet and exit to the portion of the cell where the permeant (substance) is exposed to the sample. The permeation cell of FIG. 6A can be utilized with the system of FIG. 5. The cell of FIG. 6A can be used with other pressure control systems. Referring to FIG. 6A, air or oxygen can be used on the opposite side of the accumulation chamber at a flow rate of about one chamber volume per minute (˜5-10 ml/min) in order to maintain a constant concentration on the oxygen rich side of the sample. Nitrogen, or other purge gas, can be used to purge the sensor-side of the dynamic accumulation permeation cell. While the cell need not be completely purged of oxygen to run a test, complete purging provides an opportunity to calibrate the fluorescent oxygen probe at two known levels, namely in air before purging (approximately 20.9% oxygen) and at 0% oxygen after purging. Typically, at least 10 chamber volumes of purge gas, and often much more, are used to purge the cell. Flow rates are preferably sufficiently high to quickly achieve the purge, but not high enough to expose the sample film to excessive pressure, which could stretch and damage the sample. In a specific embodiment, a flow rate of 50-100 cc/min of purge gas for about 3-5 minutes has been found to be convenient and provide good performance for a chamber volume of about 10 ml. In contrast to the steady state method, once purged, chamber valves are closed and nitrogen is shut off for the duration of the test. If sensor calibration is not required prior to a test, a successful test may be run even if the chamber is only partially purged prior to starting. In an embodiment, the dynamic accumulation chamber volume is about 8.3 ml, so very little gas is required to achieve a complete purge. Embodiments of the dynamic accumulation method may also be applied to actual packages, where the package itself becomes the accumulation chamber. When package volume is large, partial purging and/or inert material void filling may be preferred.

In specific embodiments, during the test air or oxygen can be bled or flowed into the volume exposed to the sample where the substance to travel through the sample is located, which can be referred to as the exterior, through an inlet and the contents of the exterior exposed to the sample can be allowed to bleed or flow out of an outlet to the outside environment or some other container having an appropriate pressure. In this way, the concentration of substance exposed to the sample can be kept higher during the test. In a specific embodiment, the concentration, or partial pressure, of the substance exposed to the sample can be monitored during the test as well, with, for example, a second probe, and the measured concentration used in the calculations to determine the transmission of the substance through the sample.

The pressure can be raised above, or lowered below, atmospheric pressure in a variety of manners. In a specific embodiment, the pressure on each side of the sample is raised with nitrogen, where a pressure gauge on one side of the sample provides an input to the device applying the pressure on the other side of the sample, such that the pressure is maintained the same on both sides of the sample to within a certain amount (either percentage or absolute pressure difference). The probe can be positioned on one side of the sample, such as in the interior of the chamber where the substance travels to during the test, and the portion of the exterior being maintained at the elevated pressure, or lowered pressure, can be bled in order to keep the concentration of the substance constant, were bled means to bleed a mixture or gas into the exterior exposed to the sample and allow the contents of the portion of the exterior to bleed out, such that the pressure is controlled to be at the desired pressure pattern, which can involve the pressure changing with time. Example 2 describes a specific embodiment that maintains the pressure on both sides of the sample at approximately the same pressure. Various embodiments can maintain the absolute pressure on the two sides of the sample to within 0.1%, 0.5%, 0.6%, 0.7%, 0.8%, 0.9%, 1%, 1.5%, and/or 2.0%. In further embodiments, the pressure differential between the pressure on one side of the sample and the pressure on the other side of the sample is maintained within 20 psi, 19 psi, 18 psi, 17 psi, 16 psi, 15 psi, 14 psi, 13 psi, 12 psi, 11 psi, 10 psi, 9 psi, 8 psi, 7 psi, 6 psi, 5 psi, 4 psi, 3 psi, 2 psi, and/or 1 psi. Specific embodiments can maintain the ratio of the absolute pressure of the interior (where the substance travels to) to the absolute pressure of the exterior exposed to the sample (where the substance travels from), or the ratio of the absolute pressure of the portion of the exterior exposed to the sample to the absolute pressure of the interior to be less than or equal to 1.01, 1.02, 1.03, 1.04, 1.05, 1.06, 1.07, 1.08, 1.09, and/or 1.1. In further specific embodiments, the pressure is maintained during the measurements at a pressure of a psig at least greater than 0, at least 100 psig, at least 200 psig, at least 300 psig, at least 400 psig, at least 500 psig, at least 600 psig, at least 700 psig, and/or in the range 700-1000 psig. In a further specific embodiment, the pressure is maintained during the measurements at a pressure at least 1500 psig, at least 3000 psig, at least 6000 psig, and/or between 700 psig and 6000 psig. Specific embodiments can have absolute pressures of at least 1.1 atm, 1.2 atm, 1.25 atm, 1.3 atm, 1.4 atm, 1.5 atm, 1.6 atm, 1.7 atm, 1.8 atm, 1.9 atm, and/or 2 atm.

Specific embodiments can change the absolute pressure on one or both sides of the sample, package, or portion of package, in combination with testing apparatus, the pressure difference between the sides of the sample, package, or portion of package, in combination with testing apparatus, and/or the concentration of one or more substances (e.g., gases or liquids) on one or more sides of the sample, package, or portion of package, in combination with testing apparatus as a function of time before detecting the substance (e.g., to condition the sample, package, or portion of package, in combination with testing apparatus and/or during detection of the substance. Control or modification of the concentration of the substance or other gases or liquids on one or both sides of the sample, package, or portion of package, in combination with testing apparatus can be accomplished by, for example, bleeding gases or liquids including, or not including, the substance into and/or out of the interior and/or exterior.

Referring to the embodiment shown in FIG. 5, after any calibrations that may be performed, the system can be quasi-statically pressurized. With all system valves open except the exit valve, the pressure is increased using the regulator to the desired test pressure. At this point, the whole system is pressurized with nitrogen, and the accumulation chamber can be shut-off/isolated, trapping pressurized nitrogen. Then, the opposite side of the test sample is exposed to oxygen enriched gas (air or oxygen or other mixture) at a pressure that matches the trapped pressure in the accumulation chamber, and oxygen enriched gas can be purged/bled by opening the exit valve. Maintaining matching pressures throughout the test can be accomplished, in a specific embodiment, using a dome loaded regulator, which is a regulator that is set by sensing another pressure. The dome loaded regulator can regulate oxygen pressure fed into the system by, for example, feeding gas into the system at the sensed pressure. In other specific embodiments, a dome loaded back pressure regulator can regulate the pressure in the system by venting excess gas from the system to maintain the pressure that is sensed by the dome. The back pressure regulator can become the exit valve and the bleed and purge flow rates can be controlled at the inlet. The bleed and purge flow rates can be controlled by using orifices, small bore tubing (e.g., 1/16 inch outer diameter tubing with inner diameter equal to 0.005 inches), needle valves and/or a mass flow controller.

Embodiments involve a method and apparatus for handling samples in the steady-state and/or dynamic accumulation modes. When applied to dynamic accumulation, test times have been reduced by a factor of at least 10, 20, 30, 40, and/or 50 compared with the test times for atmospheric testing with the same test gas and sample material. As an example, at 1,000 psig the test time for OTR have been reduced by a factor of about 50. This factor of the test time reduction can be increased by increasing the absolute pressure at which the test is conducted. In steady state mode, the resolution of the measurement can be improved, the ability to test extreme barriers can be provided, and/or sensor sensitivity requirements for films of lesser barrier can be reduced.

Embodiments of the present invention provide an accurate and cost-effective method and apparatus for measuring the oxygen transmission rate (OTR) of a material. Further embodiments can measure the transmission rates of other gases, vapors, and/or other airborne substances such as, but not limited to, carbon dioxide, water vapor, nitrogen, carbon monoxide, helium, hydrogen, ammonia, nitrogen oxides (NOx), sulfur oxides, hydrogen sulfide, hydrogen chloride, and aroma compounds. The particular advantage of the subject method is that it can be implemented with a variety of semi-barrier materials as a static method that does not require flowing or moving gases. In specific embodiments, the method is used on a perforated film packaging material to determine the OTR for the perforated film packaging material. In further embodiments, the method can be used to measure flow rates through non-perforated materials, such as non-perforated films.

Embodiments of the invention can use a mixture in the interior at the start of the test having a variety of constituents and a variety of ratios of those constituents. In a specific example testing the transmission rate of oxygen through a sample, a starting mixture of 96% N₂ and 4% H₂ can be used. In further embodiments testing the oxygen transmission rate, other non-oxygen constituents can be added. In a specific embodiment testing for the oxygen transmission rate, oxygen can be a constituent of the initial mixture in the interior, and the initial partial pressure (concentration) of oxygen can be assumed (e.g., is using air) or measured. As an example, air can be used in the interior and pure oxygen, or mixture with partial pressure of oxygen higher than air can be in portion of exterior exposed to sample.

The terms “semi-barrier” or “perforated film,” “non-perforated film” and “film” as used in the subject invention are merely for literary convenience. These terms should not be construed as limiting in any way. It should be understood that the devices, apparatuses, methods, techniques and/or procedures of the subject invention could be utilized with any material through which gases, vapors, or other substances can diffuse and/or permeate and be measured with the devices of the subject invention.

Specific embodiments can be used to measure the transmission of dissolved gases and/or solutes in liquids and/or solvents through a sample. In an embodiment, the liquid and/or solvent with the dissolved gas (e.g., oxygen) and/or solute is positioned in contact with one side of the sample and the liquid and/or solvent without the gas and/or solute can be positioned on the other side of the sample. Examples of liquids and/or solvents that can be used include water, oil, mayonnaise, ketchup, guacamole, alcoholic beverages, beer, wine, sodas, carbonated beverages, and milk.

Embodiments of the invention can also be used to conduct tests of transmission rates of a substance through a sample at a variety of temperatures, partial pressure differences for the substance greater than, or less than, 1 atm, and/or a variety of humidity levels. Specific embodiments can conduct tests at 0% humidity and at 100% humidity, and/or at humidities where the sample is plasticized.

Embodiments of the subject method can use a fiber optic oxygen sensor that does not consume oxygen. The use of a fiber optic oxygen sensor that does not consume oxygen can lead to a more accurate measurement of the OTR of the material. Specific embodiments of the invention incorporate a fluorescence based oxygen sensor, or probe. Also, the subject methods and device can utilize any of a variety of sensors, including commercially available oxygen sensors, thus making it convenient to use and keeping the cost of the method and/or apparatus low. In further embodiments, sensors that consume or remove 5% or less of the oxygen, or other gas being measured, can be used. Fiber optic sensors with appropriate sensor substances can be used for compounds and substances. Thermal conductivity detectors, and electronic nose sensors based on conductivity due to solubility in a substrate can also be utilized with the disclosed methods and devices.

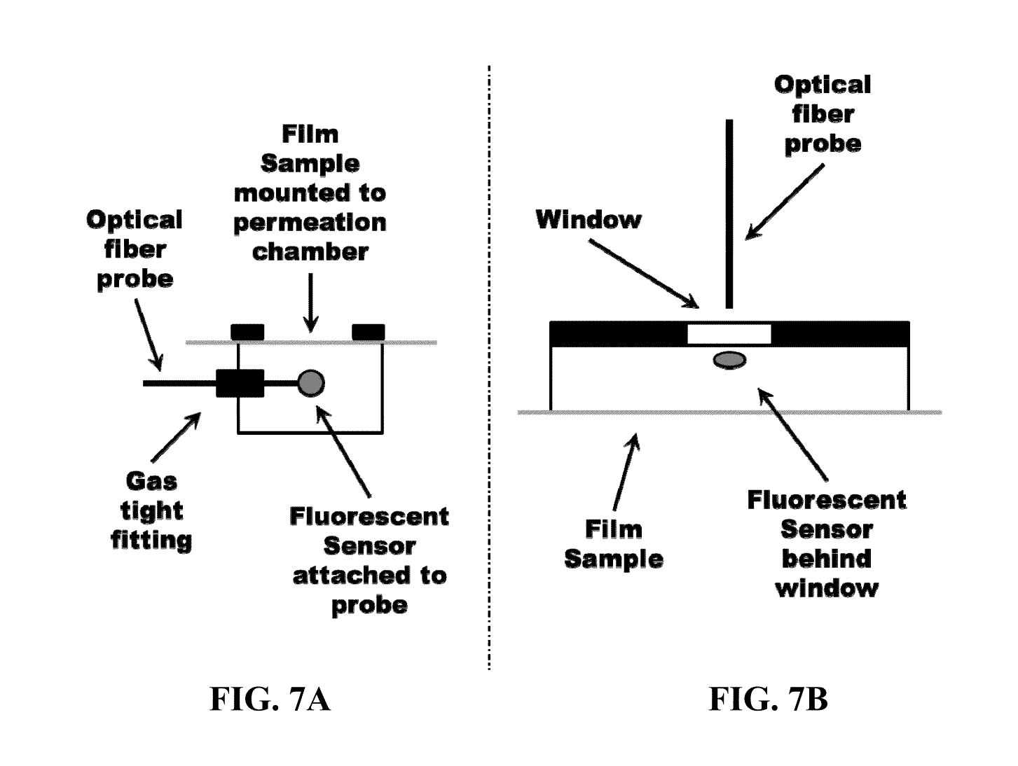

Fluorescence oxygen measurement is a non-destructive optical method for measuring oxygen concentration. The measurement can indicate the partial pressure, or concentration, of oxygen. Any fluorophore that is quenched by oxygen may be used in the oxygen measurement probe. Typically, the fluorophore is dissolved in a polymer matrix and either attached or presented to an optical fiber connected to both a light source and detector. A light source excites the fluorophore, which emits a fluorescent response at another wavelength. Due to their simplicity, stability, light purity, ruggedness, longevity, and relatively low cost, LED light sources are most commonly found in commercial instruments. Since oxygen quenches the fluorescent response, fluorescence intensity or decay constant may be reliably calibrated to oxygen concentration. Other physical properties of the fluorescence or the measurement technique, such as phase shift or phase delay of the fluorescence, can also be calibrated to oxygen concentration, and then used as an indication of oxygen concentration. When quenching of the fluorescence intensity is used, attenuation through the entire light path is important to the measurement. FIG. 7A shows an embodiment that uses an oxygen measurement probe incorporating an optical fiber coupled to the fluorescent material, which guides the fluorescence to the detector. When altering of the fluorescent decay constant due to the presence of oxygen is relied on, or when a phase shift of the fluorescence due to the presence of oxygen is relied on, a more robust means of measurement can be obtained and physical separation of the fluorescent compound from the light source and/or the detector can be implemented. In an embodiment, as shown in FIG. 7B, excitation of the fluorescent sensor and/or measurement of the fluorescence can be accomplished through, for example, an optically clear window for the case of a permeation chamber, or non-destructively through the wall of an optically clear package. The probe structure shown in FIG. 7B, where the portion of the probe having the fluorophore exposed to the oxygen can be physically separated from the portion of the probe that receives the fluorescence and the portion of the probe that excites the fluorophore, can be used with probes that rely on fluorescent decay constant and/or phase delay. The probe structure of FIG. 7B can be used with probes that rely on fluorescent intensity, but can be difficult to use as the entire light path can impact the light intensity. In alternative embodiments, an optical fiber tip may be coated with the fluorescent compound and mounted in a permeation chamber or package through a gas-tight fitting as shown in FIG. 7A. The probe structure shown in FIG. 7A can be used with probes that rely on quenching of fluorescence intensity, fluorescence delay constant, and/or fluorescence phase shift. Embodiments of the invention can use fluorophores such as platinum, palladium, and ruthenium as the fluorophore.

Embodiments for measuring the transmission rate of CO₂ can use a CO₂ sensor to detect the concentration of CO₂ in the accumulation chamber (interior), where a pH based sensor can be used due to CO₂ equilibrium with carbonic acid, a thermal conductivity sensor can be used, an infra red based sensor can be used, and/or a fluorescence based sensor can be used. Embodiments for measuring the transmission rate of water vapor can use a water vapor sensor to detect the concentration of water vapor in the accumulation chamber (interior), where a thermal conductivity based sensor can be used, an infra red based sensor can be used, a fluorescence based sensor can be used, an electrical conductivity based sensor can be used, and/or a light scattering based sensor using light scattered on a chilled mirror (due to condensation at dew point) can be used.

In a specific embodiment, a container to be tested, such as a milk carton, soda container, food can, or other container for which knowledge of the OTR of one or more substances is desired, can be used as the chamber for testing. At least a portion of a probe can be positioned within the container. The portion of the probe in the container senses the substance, such as oxygen, and sends a signal to another portion of the probe outside the container or sends a reading outside the container. Such a signal can be sent via, for example, light, electricity, electromagnetic signal, or other type of signal. The portion of the probe in contact with the interior of the container can, optionally, also receive a signal or excitation from outside the container, so as to control or excite the sensing portion of the probe. In a preferred embodiment, the probe portion positioned within the container communicates with the exterior via light passing through the container wall, or window positioned in the container wall. As an example, an oxygen probe based on fluorescence positioned within the container can be excited by light entering the interior of the container through the container wall, and light from the probe can be detected after passing from the interior to the exterior through the container wall, such as through a window in the container wall or through the container wall material. Alternatively, the light from the probe can be detected within the container and a signal sent out from the interior to the exterior via, for example, a port through the container wall. The sample, then, is the walls of the container, such that the test results incorporate the structure of the container. The walls of the container can be made of any material, and can be of any design or structure, for which it is desired to measure the transmission of one or more substances from the exterior to the interior and/or from the interior to the exterior.

In another specific embodiment, the container walls do not allow passage of the substance under test, and the cap and/or interconnection of the cap and the rest of the container is, therefore, tested, such as the cap material and/or the seal between the cap and the rest of the container. A substance can then be introduced to, or otherwise present in, the interior, or exterior, and the transmission of the substance to the exterior, or interior, respectively can be determined by measuring the presence of concentration as a function of time, and/or other parameter of the presence of the substance in the exterior, or interior respectively. Specific embodiments can test a container and involve replacing one or more portions of the container during the testing with a portion of the testing apparatus, such as replacing the cap or a portion of the wall of the container with a portion of the testing apparatus. The combination of the portion of the package and the testing apparatus can define an interior and an exterior such that the interior is separated from the exterior by one or more walls of the package and the testing apparatus. The combination can then be placed in a pressure chamber, where the pressure chamber controls the pressure of the exterior in contact with the combination. The testing apparatus allow the pressure of the interior to be controlled as well. In a specific embodiment the container itself can define the interior and exterior, and can, optionally, be placed in the pressure chamber. A substance can then be released within, or introduced into, the interior or exterior and detected in the exterior or interior respectively, while the pressures in the interior and exterior are above or below atmospheric pressure and the differential pressure between the interior and exterior is maintained to meet a desired criterion. In this way, portions of the container can be tested independently of other portions of the container. Such embodiments can use atmospheric pressure or pressures exceeding atmospheric pressures. Specific embodiments can use pressures below atmospheric pressures.

Embodiments of the method and apparatus in accordance with the present invention are particularly useful with perforated films, since no flowing gases are used. Furthermore, reducing, or eliminating, the use of flowing gases for the detection of oxygen that has passed through a material can reduce, or eliminate, the need for expensive equipment to precisely control pressures and flow rates of gases.

Specific embodiments of the subject method are more efficient, accurate, and cost-effective than currently existing OTR measurement methods. A specific embodiment of the subject method and apparatus for measuring the OTR of a semi-barrier material, such as a plastic packaging film, involves locating oxygen, or allowing oxygen to be provided, on one side of the barrier material/film and providing a fiber optic oxygen sensor on the other side of the material. Oxygen permeates through the barrier material or film and is detected by the fiber optic oxygen sensor, which can then produce a time-dependent signal to be analyzed. This method can work well with perforated and non-perforated film material because the measurements represent the concentration of oxygen that has permeated through the film material.

Sensors based on fluorophores are known in the art and are commercially available for use with embodiments of the present invention. In a fluorescence based fiber optic sensor, fluorophores can be suspended in a sol-gel complex and mounted at the tip of a fiber optic probe. One such fluorescence based fiber optic sensor is an oxygen probe available from Ocean Optics Inc. (Dunedin, Fla.), which uses a fluorescing ruthenium complex. For durability, probes may be mounted in rigid shafts, such as, for example, steel shafts of varying diameter in a manner that resembles hypodermic needles. In a specific embodiment, an 18 gauge probe, such as Model FOXY 18G by Ocean Optics Inc can be used. To operate this oxygen probe from Ocean Optics, a pulsed blue LED sends light, at 475 nm, onto an optical fiber. The optical fiber carries the light to the probe tip, which excites the fluorophore to cause an emission at ˜600 nm. In another specific embodiment, Model 5250i from Oxysense, Inc. (Dallas, Tex.) can be used.

Excitation energy from the light carried through the probe tip can also be transferred to oxygen molecules in non-radiative transfers. Therefore, the probe's exposure to oxygen decreases or quenches the fluorescence signal. For an understanding of this effect, see “Quenching of luminescence by oxygen” by H. Kautsky in Trans. Faraday Soc., 35, 216-219 (1939).

Fluorescent energy from the fluorophores can be collected by the probe and carried through the optical fiber to a spectrometer. The degree of fluorescence quenching directly relates to the frequency of collisions. This relationship can provide information regarding, for example, the concentration, pressure and/or temperature of the oxygen-containing media.

Advantageously, the use of a fluorescence quenching based sensor allows for measurement of oxygen concentration without consuming any oxygen. In contrast to embodiments of the present invention utilizing the fluorescence quenching based sensor, related art methods require removal of gas from the system or consumption of oxygen, which can directly affects the permeation measurement.

Specific embodiments can utilize an oxygen probe that relies on a relationship between oxygen concentration and decay times of fluorescence and/or a relationship between oxygen concentration and fluorescence intensity. An optical fiber probe can beam a certain wavelength of visible, or other wavelength, light through a glass, or other material, window onto the fluorescing sensor mounted on the purged side (interior) of the chamber. Oxygen non-destructively quenches, or affects the decay rate of, the fluorescent response of the sensor and this is calibrated to oxygen concentration. Dynamic accumulation of oxygen can then be measured over time in order to determine OTR.

Embodiments of the subject invention provide a method for measuring OTR of a perforated or non-perforated film, or other semi-barrier material, using a modified concentration increase method. The concentration increase method involves initially purging a chamber sealed with a semi-barrier with an oxygen free gas, such as nitrogen. Oxygen tends to diffuse through the semi-barrier. The concentration of oxygen that has diffused into the chamber through the semi-barrier can be measured over time. In accordance with embodiments of the present invention, the measurement of the oxygen concentration does not consume the sensor, the sensor does not consume any gases involved in the measurement, the apparatus does not require the use or consumption of constantly flowing gases, and does not create or rely upon pressure differentials.

FIG. 4 shows a cross-section of a schematic profile of an embodiment of an apparatus for measuring OTR according to the present invention. Referring to FIG. 4, an OTR apparatus is, in general, a chamber having a sealable hollow interior. The chamber can be constructed in a multitude of variations known to those with skill in the art. In one embodiment, the chamber incorporates a container with a sealable lid, where at least a portion of the lid can hold a portion of a sample of the semi-barrier material. In a particular embodiment, the sealable chamber can include a top section 10, a middle section 30, and a bottom section 40 that can be sealably attached. The top section 10 accommodates a film sample 50, which acts as the semi-barrier under test. The film sample can be a perforated film. The bottom section 40 can provide a lower barrier for the chamber 60 formed by the top 10, middle 30, and bottom section 40. In one embodiment, the bottom section is a separate component that can be brought into sealable contact with the middle section. The chamber can be sealed using o-rings that can fit into an o-ring groove and tightening screws that bring the top section towards the bottom section. In an alternative embodiment, the bottom section and middle section are a single piece rather than separate components. In this embodiment, the bottom and middle sections can form a single unit with a hollow interior open at one end. The open end can be sealably connected to the top section to form a sealed hollow chamber.

In a further embodiment, the middle section can include one or more inlet ports 53 for introducing into the chamber interior a non-testing substance or a substance that does not affect the probe, and one or more outlet ports 55 for flushing the non-testing substance from the chamber 50. It can also include a sensor port 59 for mounting a probe, such as a fiber optic oxygen probe. In the embodiment shown in FIG. 4, four ports are used, two inlet ports 53, one each for flushing the chamber with nitrogen and flushing the chamber with compressed air, a sensor port 59 for mounting a fiber optic oxygen probe within the chamber, and a gas outlet port 55 for venting the chamber 60. In alternative embodiments, the one more inlet and outlet ports can be located within other areas of the chamber, such as the bottom section or within the top or lid portion of the chamber. A person with skill in the art would be able to determine the appropriate location for the ports depending upon the configuration of the chamber components. Such variations in the chamber configuration and location of the ports are considered to be within the scope and purview of the subject invention.

The chamber can be initially purged of oxygen by using the nitrogen or compressed air port to flush the chamber. Then, as oxygen diffuses through a film sample, the fiber optic oxygen probe can be used to measure the concentration of oxygen in the chamber over time.

Tests were performed using an experimental set-up for an apparatus for measuring OTR according to an embodiment of the present invention. For this embodiment, the three sections (top 10, middle 30, and bottom 40) are fabricated from magnesium metal. However, alternative embodiments will utilize materials appropriate for the substances being tested with the methods and devices of the subject invention. A person with skill in the art would be able to determine any of a variety of materials suitable for the components of the subject invention and such variations are considered to be within the scope of the subject invention. In this embodiment, the bottom section incorporates a transparent plastic window or other non-magnetic material 32 in order to allow for a magnetic stir bar 35 within the test chamber. In an alternative embodiment, a single- or multi-blade fan can be positioned within the chamber interior to agitate the air or other substances within the interior. Alternative embodiments known to those with skill in the art, for allowing the substances permeating into the chamber to be well stirred or otherwise agitated could also be utilized with embodiments of the subject invention.

In this specific embodiment being tested, the height of the middle section is approximately 5.0 cm and is a hollow cylinder with four ports for flushing with nitrogen and compressed air, mounting the fiber optic oxygen probe, and to provide for a gas outlet valve. The middle section also accommodates O-rings for gas tight seals with the top and bottom sections. The top section is formed as a ring with an open area of approximately 50 cm² to accommodate film samples. It will be understood by those with skill in the art that the shape and dimensions of the middle section, as well as the top and bottom sections, can vary depending upon numerous factors. Such variations in size, shape and dimension of the components described herein, in so far as they do not detract from the teachings herein, are contemplated to be within the scope of this invention.

Specific embodiments can utilize a testing apparatus that can provide first chamber and a second chamber, both of which can be pressurized above or below atmospheric pressure and, optionally, have the pressure difference (e.g., absolute pressure difference or percentage absolute pressure difference) controlled. The sample can be positioned such that the sample separates a first interior of the first chamber and a second interior of the second chamber. The substance can then be present (e.g., introduced) in the first interior, or the second interior, and the substance detected in the second interior, or the first interior, respectively. Specific embodiments can have the first and second interiors have the same or similar volumes, or can have a ratio of first to second, or second to first, volume be at least 1.5, 2, 2.5, 3, 4, 5, 10, 20, or higher.

A variety of structures can be used to provide two volumes or chambers (e.g., an interior where the test substance travels to and a portion of the exterior in contact with the sample where the test substance travels from) at the same or similar absolute pressures, and a variety of system apparatus that can be used to control and manage the pressures in the two chambers. A sample is in contact with both chambers and can be at risk of deformation or destruction if the pressures are not controlled properly. The two chambers can have the same volume or different volumes. The volumes can be isolated from the exterior environment or can have one or more inlets and/or exits to input and output gases or liquids from the volumes. In a specific embodiment, the system can properly pressurize a test unit having a pair of chambers and the test (which might run several hours or more) can be initiated before or after the pair of chambers are removed from the pressurizing portion of the system. One or more additional pairs of chambers can then be pressurized and the one or more tests initiated before or after removing the pair of chambers from the pressurizing portion, such that multiple tests can be run simultaneously. In a specific embodiment, utilizing a structure with an interior chamber, and exterior chamber, with the sample positioned in contact with the interior and in contact with the exterior, and the structure removable from the pressurizing portion of the system, such that the structure can be pressurized and the substance exposed to the sample while the structure is removed from the pressurizing portion of the system, the exterior volumes can be at least 2, 3, 4, 5, 6, 7, 8, 9, and/or 10 times as large as the interior volume, or larger, in order to allow the partial pressure of the substance to remain sufficiently high during the test even after a portion of the substance has passed through the sample from the exterior to the interior chamber. The changes in partial pressures of the substance in the interior and the exterior during the test can be taken into account mathematically during the determination of the transmission rate.

In another specific embodiment, a first chamber, e.g., a container to be tested, can be placed inside the second chamber, such that the pressure inside the container is the same as the pressure on the outside surface of the container, but different from the pressure exterior to the second chamber. In a further specific embodiment, one or more inlet(s) and/or exit(s) can pass through a portion of the second chamber to reach the first chamber (e.g., container to be tested) to control the pressure within the first chamber. In another further embodiment, such as for a container having perforations, the interior of the first chamber can equilibriate to the interior pressure of the second chamber, and then the substance can be released in the first chamber and measured in the second chamber, or vice versa.

One or both of the chamber volumes can be independently adjustable. A mechanism can be used that allows one volume to expand while the other contracts the same amount, for example to assist in keeping the pressures the same within a certain tolerance.

The sample, which can be a membrane, can be positioned in a sample holder that provides support to prevent or reduce damage to the sample if the pressures in the two chambers experience a pressure differential that could damage the membrane. Such a support can be, for example, incorporated with the sample or be inherent to the sample, can be an external structure with sufficient rigidity and high enough permeability so as to allow the substance to pass through without adversely affecting the test, or can be some sort of screen structure that has openings allowing the sample to directly contact the corresponding chamber volume while still providing sufficient support. When the sample is a package or container, the package or container can be rigid, semi-rigid (i.e., semi-flexible), or flexible, and/or have subsections that are rigid, semi-rigid (i.e., semi-flexible), or flexible, or a combination thereof. When the sample is a film, films can tend to stretch at a pressure differential of 5 psi, so it is preferable to keep the pressure differential less than 20 psi, more preferably less than 10 psi, and most preferably less than 5 psi for films. Specific embodiments can be configured to keep the pressure differential to less than any desired threshold, such as less than 20 psi, 19 psi, 18 psi, 17 psi, 16 psi, 15 psi, 14 psi, 13 psi, 12 psi, 11 psi, 10 psi, 9 psi, 8 psi, 7 psi, 6 psi, 5 psi, 4 psi, 3 psi, 2 psi, and/or 1 psi.

Specific embodiments may not be able to control the absolute pressure in both chambers to achieve the desired tolerance for the pressure differential between the two chambers, but only be able to maintain the pressure differential to within the desired tolerance, where the tolerance can be in absolute pressure differential or a ratio of pressures. Other embodiments can control the pressures in both chambers to achieve a pressure differential within the desired tolerance.

Specific embodiments can then measure the pressures as needed for the test calculations. Specific embodiments can use the pressure at which the system is set to keep one or both chambers at for the test calculations, rather than using measured pressures. The pressures of the chambers can be constant during the test or can follow some time dependent regime. Specific embodiments can allow for control of the temperatures and/or humidity of the two chambers.

A specific embodiment can apply the same mechanical pressure, such as to a piston via hydraulic fluid, to each chamber as a way to maintain the same pressure in both chambers. Other embodiments may supply a pressure fluid, such as a gas or liquid, to the chamber to control the pressure. Specific embodiments may maintain a pressure differential between the two chambers to be at least a certain minimum or to be within a desired tolerance of a desired pressure differential. Maintaining the pressure differential at a desired pressure differential can be useful in tests representing, for example, a pressurized container exposed to atmospheric pressure, or some other pressure differential from inside the container. In this way, embodiments involve keeping one chamber at atmospheric pressure and the other chamber above, or below, atmospheric pressure.

OTR is estimated from data collected during dynamic accumulation experiments using the following model that was developed starting from the well-known relationship used to describe gas permeation through packaging films (Equation 1):

$$\frac{d {n}_{{O}_{2}}}{d t} = \frac{{\overline{P}}_{{O}_{2}} A}{l} ( {p}_{{O}_{2}}^{ambient} - {p}_{{O}_{2}}^{t} ) \qquad ( 1 )$$

where n is moles of oxygen, P̅_{O}_{₂} permeation coefficient of the permeant gas through the film,

A is the sample's permeation area, 1 is sample film thickness, p_{O}_{₂}^{ambient} is partial pressure of oxygen on the oxygen rich side of the sample, p_{O}_{₂}^{t} is the partial pressure of oxygen in the dynamic accumulation chamber at time, t. Equation 1 describes the rate at which oxygen permeates through a sample of known area and thickness under a driving force defined by the partial pressure difference on either side of the sample.

When using oxygen (or air) and nitrogen, it has been shown that it may be safely assumed that the volume of the sensor side of the permeation chamber remains constant throughout the measurement (e.g., rates of transfer of oxygen and nitrogen into and from the chamber are similar). With volume and pressure constant, oxygen partial pressure is directly related to moles of oxygen via Equation 2:

$${p}_{{O}_{2}} = \frac{{n}_{{O}_{2}} RT}{{V}_{total}} \qquad ( 2 )$$

where Vₜₒₜₐₗ is total chamber volume (volume of dynamic accumulation portion of chamber), R is ideal gas law constant, and T is absolute temperature. Substitution of Equation 2 into Equation 1 yields:

$$\frac{d {p}_{{O}_{2}}}{d t} = \frac{RT}{{V}_{total}} \cdot \frac{{\overline{P}}_{{O}_{2}} A}{l} ( {p}_{{O}_{2}}^{ambient} - {p}_{{O}_{2}}^{t} ) \qquad ( 3 )$$

Integrating Equation 3 from the beginning of the experiment (t=0) to time, t, yields:

$$ln [ \frac{( {p}_{{O}_{2} }^{ambient} - {p}_{{O}_{2}}^{t} )}{( {p}_{{O}_{2}}^{ambient} - {p}_{{O}_{2}}^{0} )} ] = \frac{- RT}{{V}_{total}} \cdot \frac{{\overline{P}}_{{O}_{2}} A}{l} \cdot t \qquad ( 4 )$$

We refer to the bracketed ratio on the left hand side of Equation 4 as the accomplished oxygen ratio (AOR). Initially, AOR is unity. As oxygen accumulates over time, AOR tends to zero. Equation 4 suggests that plotting natural logarithm of accomplished oxygen ratio versus time should yield a straight line with a slope proportional to OTR. Converting from moles to conventional OTR units of cm³ O₂ at standard temperature and pressure (STP) yields Equation 5:

$$OTR = \frac{\vert Slope \vert {V}_{total}}{A} \qquad ( 5 )$$

When performed at 23° C. the absolute value of the slope from a plot of natural logarithm of accomplished oxygen ratio versus time and Equation 5 provides the standard OTR value used to specify oxygen transmission performance of packaging materials. The standard OTR is defined for a partial pressure difference of 1 atmosphere. The actual OTR can be determined by multiplying the standard OTR by the actual partial pressure difference in the given situation.

Comparisons of OTR measurements of packaging films over a wide range of OTR values using both steady state and dynamic accumulation methods in accordance with embodiments of the subject invention were performed for films having OTR values in the range of 10¹-10³ ccO₂/m²/day.

### EXAMPLE 1

In a specific embodiment, OTR was determined from the dynamic accumulation model by estimating the OTR from data collected during dynamic accumulation experiments using the model provided in equation 5 that was developed starting from the well-known relationship used to describe gas permeation through packaging films, where n is moles of oxygen, P̅_{O}_{₂} is permeation coefficient of the permeant gas through the film, A is the sample's permeation area, 1 is sample film thickness, p_{O}_{₂}^{ambient} is partial pressure of oxygen on the oxygen rich side of the sample, and p_{O}_{₂}^{t} is the partial pressure of oxygen in the dynamic accumulation chamber at time, t. Equation 1 describes the rate at which oxygen permeates through a sample of known area and thickness under a driving force defined by the partial pressure difference on either side of the sample.

Three commercially produced film samples were selected from laboratory film stock to provide a broad range of OTR for measurement comparisons. For this example, films were labeled in a relative sense as “high barrier,” “medium barrier” and “low barrier” according to the expected approximate OTR levels shown in Table 1:

TABLE 1
Target OTR ranges for test samples.

| | Approximate OTR Range |
|---|---|
| Description | (cc/m²/day) |
| High Barrier | 10 |
| Medium Barrier | 1000 |
| Low Barrier | 10000 |

Steady-state measurements were performed in accordance with ASTM D-3985 using a Mocon Oxtran 2/20 (Mocon, Inc., Minneapolis, Minn.). Temperature was set to 23° C. and the instrument was set to convergence mode, which instructs the instrument to take readings until two consecutive readings differ by less than 5%. Six repetitions were made for the “high barrier” film on the Oxtran 2/20 “MH” module (Mocon, Inc., Minneapolis, Minn.), which is pre-tuned for higher barrier (low OTR) samples. Twelve measurements were made on the moderate and high transmitter films on the Oxtran 2/20 “ST” module (Mocon, Inc., Minneapolis, Minn.), which is tuned for low barrier (high OTR) samples.

Dynamic accumulation experiments were performed using permeation cells and fluorescence oxygen detection equipment from Oxysense, Inc. (Dallas, Tex.) (Oxysense Model 310 or Model 325, Dallas, Tex.). The oxygen accumulation chamber had a sample area of 16.62 cm² and a volume of 8.3 cm³ as measured using water displacement weight. Initially the cell was purged with industrial grade compressed nitrogen. For the “low barrier” film the oxygen enriched side was fed compressed air from our laboratory's air compressor. For the “high barrier” and “medium barrier” samples, industrial grade oxygen was used. Oxygen concentration in the dynamic accumulation chamber was measured and recorded periodically during the test using a commercially available oxygen fluorescence sensor (Oxysense Model 310 or Model 325). OTR was subsequently calculated as described previously.

Temperature control was achieved using a shelf-top mini-refrigerator equipped with a 100W light bulb controlled by a PID temperature controller. The PID controller was set to 23° C. and was capable of controlling temperature to ±0.2° C.

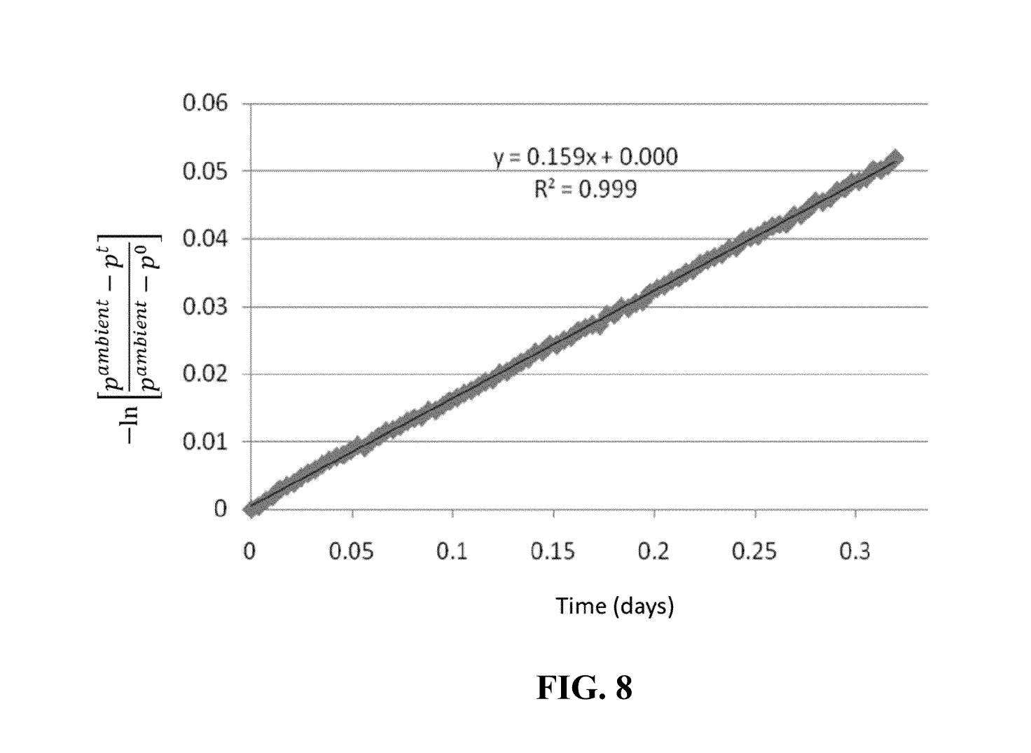

FIG. 8 shows a typical experimental response using the dynamic accumulation method. FIG. 8 confirms the expectation provided by Equation 4, which suggested a straight line from a plot of natural log of accomplished oxygen concentration ratio versus time.

Results from OTR measurements using both methods are summarized in Table 2:

TABLE 2
Measured OTR values using dynamic accumulation and
steady state methods.

| | | Dynamic | | | |
|---|---|---|---|---|---|
| | | Accumulation | | Steady State | |
| | Samples | OTR | (±95 CI) | OTR | (±95 CI) |
| Description | (n) | cc/m²/day | | cc/m²/day | |
| High Barrier | 6 | 6.8 | 0.5 | 7.4 | 0.3 |
| Medium Barrier | 12 | 840 | 30 | 780 | 70 |
| Low Barrier | 12 | 9700 | 200 | 9600 | 700 |

Mean results were tested for differences at the 95% confidence level. Results of the means tests are shown in Table 3.

TABLE 3
95% Confidence Interval on differences of means between
the Dynamic Accumulation and the Steady State Methods.
Results show no difference in results determined using both
methods at the 95% confidence interval (CI) level.

| | | μ_{Dynamic Accumulation} − μ_{Steady State} | | |
|---|---|---|---|---|
| | | 95% CI | Mean | 95% CI |
| | Samples | Lower Bound | Differences | Upper Bound |
| | (n) | cc/m²/day | | |
| High Barrier | 6 | −1.3 | −0.6 | 0 |
| Medium | 12 | −31 | 60 | 140 |
| Barrier | | | | |
| Low Barrier | 12 | −660 | 100 | 950 |

Tables 2 and 3 show there are no differences at a 95% confidence interval in the average OTR of the films measured by both the dynamic accumulation method using a fluorescence oxygen sensor and the steady state method using a coulometric sensor.

### EXAMPLE 2

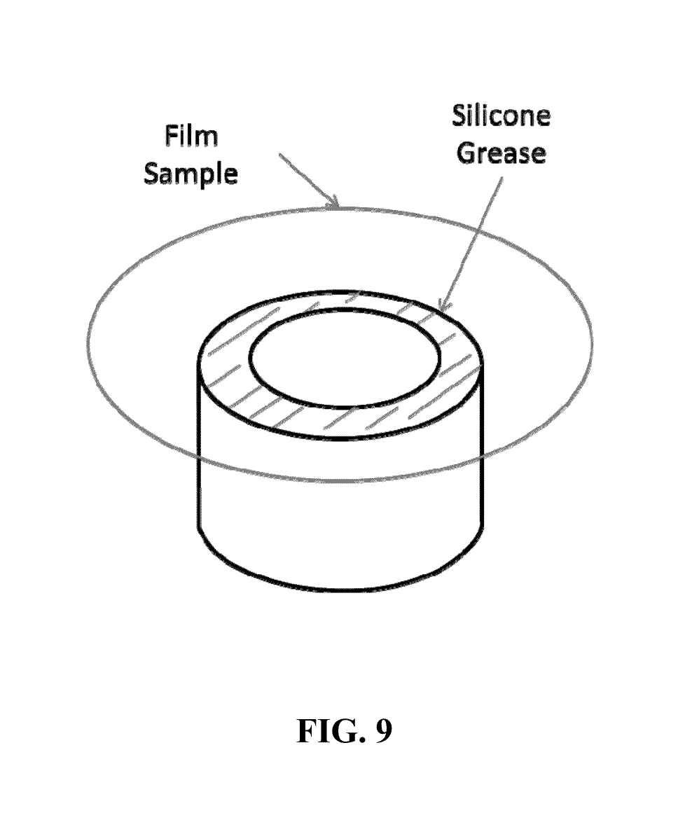

FIG. 5 shows a system diagram for a high performance dynamic oxygen accumulation permeability measurement system. An example of a testing apparatus that can be used as a portion of the system shown in FIG. 5 and labeled testing apparatus is shown in FIG. 6A. Initially, all valves, regulators, and supply tanks are in the closed position. Once it is verified that all valves, regulators, and supply tanks are in the closed position, the sample chamber can be opened and the sample mounted. A sealing material, such as silicone grease, can be used to secure the sample and to allow for the sample to be pulled taut, as shown in FIG. 9.

Once the sample is in position, the top of the dynamic accumulation chamber can be put back in position and secured. A sensor, such as an optical fiber sensor, can then be positioned to monitor the concentration of one or more gases in the accumulation chamber. In a specific embodiment, an optical fiber sensor can be used to monitor the oxygen concentration in the accumulation chamber. In a further specific embodiment, the fiber optic sensor can be positioned in a receptacle provided in the top of the accumulation chamber, as shown in FIG. 6A. The receptacle can be an opening slightly larger than the tip of the optical fiber (or light pen) of the probe and a window at the bottom of the opening such that the chamber is separated from the environment while allowing fluorescence to pass through the window and be captured by the optical fiber (or light pen). In an embodiment the window can be made of a transparent material such as glass or polycarbonate.

Generally, fluorescence probes are calibrated to air and 0% oxygen prior to use. Optionally, as needed or desired, the oxygen sensing system can be calibrated and a high oxygen reading and/or low oxygen reading acquired. In an embodiment utilizing an Oxysense, Inc. (Dallas, Tex.) oxygen sensor, (note, other sensors can be utilized in accordance with embodiments of the subject invention, where a description of an embodiment using an Oxysense, Inc. (Dallas, Tex.) oxygen sensor is provided in this example for illustration purposes) the “calibrations” tab of the Oxysense, Inc. (Dallas, Tex.) software can be selected and the “Capture” tab can be used to capture an initial reading. It can then be verified that the oxygen reading is approximately 21% and 20.9% can be entered for the high value. The “Get High” tab can be selected and a high value can be acquired. Once this high value is obtained, the system can be flushed with nitrogen prior to acquiring the “Get Low” value, or low oxygen reading.

Regarding flushing the system with nitrogen, in an embodiment, referring to FIG. 5, the nitrogen tank regulator output pressure is initially set lower than required to deliver nitrogen. The EXIT needle valve is then opened fully. Working backward from the EXIT needle valve, the TOP_OUT and TOP_In ball valves are opened. The nitrogen tank is then opened, setting the nitrogen tank regulator to a minimal pressure value (for example approximately 5-10 psig), which helps to ensure that the sample film will not be stretched when the valves are opened. In particular, the sample film can be stretched if the valves are opened too quickly if the nitrogen tank regulator is set to too high of a pressure value. The N2_IN needle valve can then be slowly opened, for example, until a faint sound of gas can be heard from the EXIT needle valve, in order to allow nitrogen to flow out from the nitrogen tank regulator. The system is now purging while the nitrogen is flowing.

The “Capture” button can be selected on the calibration page of the software to observe estimated oxygen values in the dynamic accumulation chamber. After a few minutes, when the reading stops decreasing, the N2_IN needle valve can be slowly closed so as to just barely maintain positive flow from the EXIT needle valve. In a specific embodiment, a gas flow meter can be attached to the EXIT port and the N2_IN needle valve can be slowly closed until the flow rate is sufficiently low, such as at or below 10 sccm on the gas flow meter. The low oxygen value can then be acquired by clicking the “Get Low” button on the calibration page of the software.

Calibration constants can then be calculated. In a specific embodiment, incorporating an oxygen sensor from Oxysense, Inc. (Dallas, Tex.), calibration constants “dA” and “dB” can be calculated, where A and B are linear regression coefficients fit to fluorescent decay curves and dA and dB are the changes of those coefficients over the calibrated range, by clicking the “Calculate New dA and dB” button. If the values are acceptable, the value can be saved by clicking to save these values, and then clicking “Ok” on the appropriate screen. The new dA and dB can also be recorded and associated with the appropriate dynamic accumulation permeation chamber and/or measurement.

The “Film Permeation” tab can be selected and the chamber name entered and a new active data set created. All known values for the chamber can be inputted and newly recorded “dA” and “dB” values entered and/or associated with the measurement. “View Log” can then be selected to show the data acquisition page.

The system can then be pressurized. In an embodiment, the operating pressure of the system can be set with the nitrogen regulator. In a specific embodiment, in order to initiate pressurizing the system, the EXIT needle valve can be shut while the remaining valves can be left as they were (open) at the end of calibrating the system. Using the nitrogen tank regulator, the output pressure can be increased to the desired working pressure for the experiment (e.g., 700 psig). Once the desired pressure is reached, the TOP_OUT valve can be closed to isolate the dynamic accumulation chamber from the oxygen rich chamber. In this way, the system is “statically” pressurized.

Next, oxygen rich gas can be applied to flush the oxygen rich chamber. First, it is confirmed that the AIR_IN needle valve is closed. The compressed air/oxygen tank can then be opened. The pressure can be set using the regulator, at approximate 1.2-1.3 times the operating pressure set on the nitrogen regulator. This ensures a proper step down pressure at the dome loaded regulator. The AIR_IN needle valve is slowly opened. The Exit valve is very slowly opened, to about, for example, 250 sccm, to rapidly replace nitrogen from the bottom flush chamber with air/oxygen. This flushing should occur long enough to flush out the nitrogen. In a specific embodiment, the flushing is allowed to continue until about 5-10 flush chamber volumes enter the flush chamber to purge all nitrogen (typically 2-4 minutes). After purging, the outlet flow can be slowly reduced using the EXIT needle valve, for example, to about 10 sccm. At this point, the system is properly pressurized and ready for testing. An initial data point can be collected and then the “Timer” can be set for automated data collection.

After completion of the test, the system can be depressurized in order to replace the sample. In order to depressurize the system, the EXIT needle valve can be closed to stop gas from flowing. Then all gas tank valves can be closed. N2_IN can be closed and AIR_IN needle valves can be closed. The TOP_OUT ball valve can then be opened to eliminate isolation of the chamber halves. The TOP_IN valve can be opened. The EXIT valve can then be slowly opened to allow pressured gas to slowly escape from the system. Some samples may be sensitive to rapid reductions in pressure, particularly multi-layer films, which may bubble and/or delaminate. Therefore, caution should be exercised and pressurization should be performed very slowly with pressure sensitive samples if they are to be spared or retested.

Once depressurized, the system may be opened for sample removal. The test area can be cleaned. Test data can be saved and/or exported in a format suitable for further analysis. Embodiments can automate the process such that pressurization and depressurization can be controlled as needed. Such automations can include automation of opening and closing valves, control of the duration of different actions, and data acquisition.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A method for measuring the transmission rate of a substance through a sample, comprising:
providing a chamber having one or more walls that define an interior and an exterior, wherein the one or more walls have an aperture therethrough such that the interior communicates with the exterior through the aperture;
positioning a sample proximate the aperture such that the exterior and the interior are separated by the sample, wherein an exterior side of the sample is in contact with the exterior and an interior side of the sample is in contact with the interior;
maintaining an interior pressure in the interior and an exterior pressure in the exterior such that the interior or exterior pressure is above, or below, atmospheric pressure, wherein the exterior pressure and the interior pressure meet a criterion, wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential;
exposing the exterior side of the sample to a substance;
positioning at least a portion of a probe in contact with the interior; and
detecting the substance in the interior via the probe.

2. The method according to claim 1, wherein the interior pressure or the exterior pressure above atmospheric pressure.

3. The method according to claim 1, wherein the interior pressure or the exterior pressure below atmospheric pressure.

4. The method according to claim 1, wherein the interior pressure is less than the exterior pressure and the ratio of the interior pressure to the exterior pressure is at least the first minimum ratio, or the exterior pressure is less than the interior pressure and the ratio of the exterior pressure to the interior pressure is at least the second minimum ratio.

5. The method according to claim 1, wherein the difference between the interior pressure and the exterior pressure is less than or equal to the maximum pressure differential.

6. The method according to claim 1, wherein the difference between the interior pressure and the exterior pressure is approximately a desired pressure differential.

7. The method according to claim 4, wherein the maximum pressure differential is 5 psi.

8. The method according to claim 1, wherein exposing the exterior side of the sample to the substance comprises introducing the substance to the exterior such that the substance is in contact with the sample.

9. The method according to claim 1, wherein the interior pressure or the exterior pressure is at least 1.1 times atmospheric pressure.

10. The method according to claim 1, wherein the interior pressure or the exterior pressure is at least 700 psig.

11. The method according to claim 1, wherein the probe comprises a fluorophore, wherein the fluorophore is in contact with the interior.

12. The method according to claim 1, further comprising:
providing an inlet port for passing a purge fluid to the interior; and
providing an outlet port for allowing fluid to pass from the interior, such that when the purge fluid is inputted through the inlet port, fluid in the interior is purged from the interior through the outlet port.

13. The method according to claim 1, wherein the sample is perforated.

14. The method according to claim 13, wherein the sample comprises a non-permeable material.

15. The method according to claim 1, wherein the sample is non-perforated.

16. The method according to claim 15, wherein the sample comprises a permeable material.

17. The method according to claim 1, wherein the substance is oxygen.

18. The method according to claim 1, wherein the substance is water vapor.

19. The method according to claim 1, wherein the substance is carbon dioxide.

20. The method according to claim 1, further comprising providing a port for insertion of the at least a portion of the probe into the interior.

21. The method according to claim 17, wherein the probe comprises:
a fluorophore,
a light source for illuminating the fluorophore, and
a detector for detecting fluorescence from the fluorophore.

22. The method according to claim 17, wherein the at least a portion of the probe in contact with the interior is entirely within the interior, wherein light given off by the at least a portion of the probe passes through the one or more walls, wherein a second portion of the probe detects the light given off by the at least a portion of the probe.

23. The method according to claim 21, wherein oxygen quenches fluorescence from the fluorophore.

24. The method according to claim 21, wherein oxygen affects an intensity of fluorescence from the fluorophore.

25. The method according to claim 21, wherein oxygen affects a decay rate of fluorescence from the fluorophore.

26. The method according to claim 21, wherein oxygen causes a phase shift of fluorescence from the fluorophore.

27. The method according to claim 21, wherein the device determines a concentration of oxygen in the interior from the detected fluorescence.

28. The method according to claim 12, wherein the purge fluid is a gas or gas mixture.

29. The method according to claim 12, wherein the purge fluid is a liquid.

30. The method according to claim 1, wherein the substance is selected from the group consisting of: nitrogen, carbon monoxide, helium, hydrogen, ammonia, nitrogen oxides (NOx), sulfur oxides, hydrogen sulfide, hydrogen chloride, and aroma compounds, and Uranium Hexafluoride.

31. The method according to claim 8, wherein the substance is introduced into the exterior such that the substance is in contact with the sample via a medium, wherein the medium is in gaseous form.

32. The method according to claim 8, wherein the substance is introduced into the exterior such that the substance is in contact with the sample via a medium, wherein the medium is in liquid form.

33. The method according to claim 32, wherein the substance is dissolved in the medium.

34. The method according to claim 32, wherein the substance is a solute, wherein the medium is a solution comprising the substance.

35. The method according to claim 1, wherein the substance is a gas.

36. The method according to claim 1, wherein the probe does not consume the substance during detection.

37. The method according to claim 1, wherein the transmission rate is based on the time dependence of the transmission of the detected substance through the sample.

38. The method according to claim 17, wherein the probe detects oxygen, wherein the probe does not consume oxygen during detection.

39. The method according to claim 12, wherein the purge fluid is passed to the interior prior to detecting the substance in the interior via the probe.

40. The method according to claim 1, further comprising:
providing an exterior inlet port for passing a fluid to the interior; and
providing an exterior outlet port for allowing fluid to pass from the exterior, such that when fluid is inputted through the exterior inlet port, fluid in the exterior passes from the exterior through the exterior outlet port, wherein fluid is inputted through the exterior inlet port, such that fluid in the exterior passes from the exterior through the exterior outlet port during exposing the exterior side of the sample to the substance.

41. The method according to claim 1, further comprising determining a transmission rate of the substance through the sample based on the detected substance.

42. A device for measuring the transmission rate of a substance through a sample, comprising:
a chamber having one or more walls that define an interior and an exterior, wherein the one or more walls have an aperture therethrough such that the interior communicates with the exterior through the aperture,
a sample holder, wherein the sample holder is configured to position a sample proximate the aperture such that the exterior and the interior are separated by the sample,
wherein the device is configured to maintain an interior pressure of the interior or an exterior pressure of the exterior above, or below, atmospheric pressure,
wherein the device is configured to maintain the interior pressure and the exterior pressure such that the exterior pressure and the interior pressure meet a criterion,
wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential; and
a probe, wherein at least a portion of the probe is in contact with the interior such that the probe can detect a substance in the interior.

43. The device according to claim 42, wherein the device is configured to maintain the interior pressure or the exterior pressure above atmospheric pressure.

44. The device according to claim 42, wherein the device is configured to maintain the interior pressure or the exterior pressure below atmospheric pressure.

45. The device according to claim 42, wherein the interior pressure is less than the exterior pressure and the ratio of the interior pressure to the exterior pressure is at least the first minimum ratio, or the exterior pressure is less than the interior pressure and the ratio of the exterior pressure to the interior pressure is at least the second minimum ratio.

46. The device according to claim 42, wherein the difference between the interior pressure and the exterior pressure is less than or equal to the maximum pressure differential.

47. The device according to claim 42, wherein the difference between the interior pressure and the exterior pressure is approximately a desired pressure differential.

48. The device according to claim 42, wherein the device is configured to determine a transmission rate of the substance through the sample based on the detected substance.

49. A method for measuring the transmission rate of a substance through at least a portion of a package, comprising:
providing at least a portion of a package having one or more walls;
interconnecting the at least a portion of the package with a testing apparatus such that an interior and an exterior are defined by the at least a portion of the package in combination with the testing apparatus, wherein the interior and the exterior are separated by the at least a portion of the package in combination with the testing apparatus;
positioning the at least a portion of the package in combination with the testing apparatus inside a pressure chamber;
maintaining an interior pressure in the interior or an exterior pressure in the pressure chamber above, or below, atmospheric pressure;
maintaining the exterior pressure and the interior pressure such that the interior pressure and the exterior pressure meet a criterion, wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential; and
locating a substance in either the exterior, or the interior;
positioning at least a portion of a probe in contact with either the interior, or exterior, respectively, wherein the substance in either the exterior, or the interior, respectively, is detected by the probe.

50. The method according to claim 49, further comprising:
determining a transmission rate of the substance through the at least a portion of the package based on the detected substance.

51. A device for measuring the transmission rate of a substance through at least a portion of a package, comprising:
a testing apparatus, wherein the testing apparatus is configured to connect to at least a portion of a package having one or more walls such that an interior and an exterior are defined by the at least a portion of the package in combination with the testing apparatus, wherein the interior and the exterior are separated by the at least a portion of the package in combination with the testing apparatus;
a pressure chamber configured to receive the at least a portion of the package in combination with the testing apparatus such that the at least a portion of the package in combination with the testing apparatus is inside the pressure chamber;
wherein the device is configured to maintain an interior pressure in the interior and an exterior pressure in the pressure chamber such that the interior pressure or the exterior pressure is above, or below, atmospheric pressure,
wherein the device is configured to maintain the interior pressure and the exterior pressure such that the exterior pressure and the interior pressure meet a criterion, wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential; and
a probe, wherein the device is configured to position at least a portion of a probe in contact with either the interior, or the exterior, and detect a substance located in either the exterior, or the interior, respectively.

52. The device according to claim 51, wherein the amount of the substance in either the exterior, or the interior, respectively, provides a transmission rate of the substance through the sample.

53. A method for measuring the transmission rate of a substance through a sample, comprising:
flowing a first gaseous flow across a first surface of a sample, wherein the first gaseous flow comprises a substance, wherein the first gaseous flow is conducted at a first pressure;
flowing a second gaseous flow across a second surface of the sample, wherein the second gaseous flow is conducted at a second pressure, wherein the first pressure or the second pressure is higher or lower than atmospheric pressure;
wherein the exterior pressure and the interior pressure meet a criterion, wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential; and
detecting the substance in the second gaseous flow after the second gaseous flow has flowed across the second surface.

54. The method according to claim 53, wherein the amount of the substance in the second gaseous flow after the second gaseous flow has flowed across the second surface provides a transmission rate of the substance through the sample.

55. A device for allowing a substance to transfer through a sample, comprising:
a first flow chamber;
a second flow chamber;
a sample holder, wherein the sample holder is configured to position a sample such that the first flow chamber and the second flow chamber are separated by the sample;
wherein the device is configured such that a first gaseous flow flows in the first flow chamber such that the first gaseous flow flows across a first surface of a sample, wherein the device is configured such that the first flow chamber is at a first pressure,
wherein the device is configured such that a second gaseous flow flows in the second flow chamber such that the second gaseous flow flows across a second surface of the sample, wherein the device is configured such that the second flow chamber is at a second pressure, wherein the device is configured such that the first pressure or second pressure is higher or lower than atmospheric pressure, wherein the device is configured such that the exterior pressure and the interior pressure meet a criterion, wherein the criterion is selected from the group consisting of the following:
(i) the interior pressure is less than the exterior pressure and a ratio of the interior pressure to the exterior pressure is at least a minimum ratio or the exterior pressure is less than the interior pressure and a ratio of the exterior pressure to the interior pressure is at least the minimum ratio,
(ii) a difference between the interior pressure and the exterior pressure is less than or equal to a maximum pressure differential, and
(iii) the difference between the interior pressure and the exterior pressure is approximately a desired pressure differential; and
a probe, wherein the device is configured to detect a substance in the second gaseous flow via the probe after the second gaseous flow has flowed across the second surface when the first gaseous flow comprises a substance.

56. The device according to claim 55, wherein the amount of the substance in the second gaseous flow after the second gaseous flow has flowed across the second surface provides a transmission rate of the substance through the sample.
